(19) United States
(12) Patent Application Publication
(10) Pub. No.: US 2009/0132666 A1
(43) Pub. Date: May 21, 2009

(54) Method and apparatus for implementing a network based debugging protocol

(76) Inventor: Shahriar Rahman, San Jose, CA (US)

Correspondence Address: Daniel M. DeVos;Blakely, Sokoloff, Taylor & Zafman LLP, Seventh Floor, 12400 Wilshire Boulevard, Los Angeles, CA, 90025-1030, US

(21) Appl. No.: 11/985,600

(22) Filed: Nov. 15, 2007

(51) Int. Cl. G06F 15/16

(52) U.S. Cl. 709/206

(57) ABSTRACT

Techniques for automatically triggering debug sessions across a network are described herein. In one embodiment of the invention, at a first code module in a first computing device, a detected event is determined to constitute an automatic start network debug session condition, wherein the detected event is an occurrence of significance to the first code module, and wherein the automatic start debug session condition is a set of one or more start criterions of which the detected event is a part. One or more actions for that automatic start network debug session condition are determined, wherein each action includes properties of a different one of the one or more debug sessions. A destination of at least one of the actions is determined to be a second computing device. An automatic network debug message is formed for each action destined for the second computing device, wherein the automatic network debug message is based on that action and wherein the automatic network debug message indicates the properties of the debug session. Each automatic network debug message destined for the second computing is transmitted to the second computing device. Upon receiving the automatic network debug messages, the second computing device processes each received automatic network debug message, wherein processing includes reforming the action from the received automatic network debug message and sending the reformed action to a local code module upon determining that the local code module should automatically start a debug session. One or more flags are set according to each reformed action to start the debug session corresponding to each reformed action, and a set of one or more debug messages are generated corresponding to the flags that are set. Other methods and apparatuses are also described.

### CROSS-REFERENCE TO RELATED APPLICATIONS

Not Applicable.

### BACKGROUND

1. Field

Embodiments of the invention relate to the field of debugging; and more specifically, to automatically triggering debugging sessions across a network.

2. Background

Debugging techniques exist to generate debug messages to monitor, administer, and troubleshoot networked computing devices (e.g., computing devices that are interconnected in a network). As an example, debug messages may provide network administrators information regarding a problem in one of the networked computing device. The information in the debug message may allow the network administrator to identify and resolve the problem (e.g., troubleshooting). Debug messages are generated in a time period known as a debug session. Debug sessions in the prior art must be manually started and stopped. Debug messages are generated continuously during the debug session until the debug session has been stopped.

Typical debugging techniques require a network administrator to determine whether to generate debug messages (e.g., whether to start a debug session) and what module in a network computing device should generate debug messages. The network administrator likely does not want every module in the networked computing device to generate debug messages as the amount of debug messages that could be generated by every module may be too large to effectively process (e.g., the network administrator can be overwhelmed with debug messages). Additionally, generating debug messages impacts system performance of the networked computing device (e.g., processing load, memory consumption, storage capacity, etc.) Therefore the network administrator desires only to generate debug messages relative to the task at hand. For example in the common case of troubleshooting a problem, the network administrator desires only to generate debug messages relative to the problem.

Choosing which debug messages to generate (e.g., which module on which network computing device should generate debug messages) is not a trivial task for the network administrator. In the case of troubleshooting a problem, typically the network administrator makes a prediction of what the problem is and where (e.g., module, interface, etc.) the problem is occurring. In the case of a distributed networked system (e.g., many different computing devices in the network) the network administrator must further make a prediction of which networked computing device is causing the problem. After these predictions, the network administrator configures debug messages to be generated in the networked computing device where the problem is likely occurring. If this prediction is wrong (e.g., the debug messages do not provide information relevant to the problem) the network administrator configures debug messages to be generated somewhere else in the network. By this repeating process of prediction and selective generation of debug messages the network administrator hopes to identify and fix the problem. It should be understood that as the complexity of the network grows (e.g., as the number of networked computing devices increases) the more difficult the task of resolving a problem becomes. In addition to the time and effort it may take the network administrator to complete this process, in the case of a rare problem (e.g, a problem not usually encountered) the network administrator may not be able to locate and resolve the problem regardless of time spent debugging.

In the prior art, debug sessions must be manually started and stopped. One way of manually starting a debug session and limiting the debug messages generated during the debug session is by using filtering debugging techniques. A network administrator manually turns on preconfigured filters in one of the networked computing device (thus manually starting a debug session) and debug messages are generated consistent with that filter. As a simple example of a filter, the network administrator may limit the debug messages generated based on a certain Media Access Control (MAC) address. Thus debug messages are generated during a debug session only for that certain MAC address. Another example of a filter is limiting debug messages to a certain interface of the networked computing device. However, although filtering debugging techniques limit the debug messages generated, filtering debugging techniques have the disadvantage that a network administrator must manually start the debug session (by manually turning on the filter) and manually stop the debug session. Thus, once the administrator has manually started the debug session, debugging messages are generated continuously consistent with the filter consuming valuable networked computing device resources (e.g., processing cycles, available memory, storage capacity, etc.) until the network administrator manually stops the debug session (e.g., by turning off the filter).

Additionally, another way of manually starting a debug session and limiting the debug messages generated during the debug session is by using reporting conditionally debugging techniques. A network administrator manually turns on preconfigured reporting conditions in the networked computing device (thus manually starting a debug session) and debug messages are generated consistent with the reporting condition. A reporting condition may be an event or events that occur within the networked computing device. For example, a reporting condition may be authentication failure. Thus, after a network administrator manual starts a debug session (by manually turning on the reporting condition ‘authentication failure’) the networked computing device generates debug messages for every authentication failure in the networked computing device. However, reporting conditionally debugging techniques have the disadvantage that a network administrator must manually start the debug session (by manually turning on the reporting condition) and manually stop the debug session. Thus, once the network administrator has manually started the debug session, debugging messages are generated continuously consistent with the reporting condition consuming valuable system resources (e.g., processing cycles, available memory, storage capacity, etc.) until the network administrator manually stops the debug session (e.g., by turning off the reporting condition). Additionally, reporting conditionally debugging techniques have the disadvantage that once the reporting condition is met the debug messages cannot be prevented from being generated. Filtering debugging and reporting conditionally debugging techniques may be used together. Using the above examples to illustrate, debug messages are generated upon an authentication failure for a particular MAC address.

Debug messages may be logged either internally and/or externally. Logging debug messages allows a network administrator to examine the debug messages at a later time. Debug messages may be externally logged by any known means of propagating these messages to an external system. For example, RFC3164, “The BSD syslog Protocol” (August 2001), may be used to externally log debug messages from one networked computing device to an external system. Logging debug messages to an external system allows a network administrator a single central location to examine debug messages generated from the networked computing devices.

Once the debug messages have been logged, the network administrator may use those debug messages in an effort to locate and fix the problem. Often the network administrator will use the debug messages in order to recreate the problem on a different device outside of the network. However, recreating is a time consuming process and often rare problems cannot be recreated effectively. For example, in the case of a rare problem encountered on the network, the owner of the computing devices of the network recognizes that a problem has occurred (although the owner likely does not know the cause of or any resolution of the problem) and notifies the network administrator that something is wrong. As the problem was unexpected and rare, a debug session relevant to the problem likely was not manually started (thus debug messages relevant to the problem probably were not generated). As a network administrator may not be able to resolve the problem without additional information (e.g., debug messages), the network administrator often instructs the owner of the computing devices of the network on what to do if the problem occurs again (e.g., the information to gather if the problem occurs again). If the owner of the computing devices on the network recognizes the problem again, and is able to gather the information, the network administrator may be able to recreate the problem and resolve that problem with the use of the gathered information. However, the information gathered may not be sufficient to resolve the problem and the network administrator may have to further instruct the owner of the computing device to gather different information. This process is repeated until the network administrator can resolve the problem. As should be understood, the rarer the problem is the more likely that the process will be repeated and a significant amount of time will be spent undertaking this process.

### BRIEF DESCRIPTION OF THE DRAWINGS

The invention may best be understood by referring to the following description and accompanying drawings that are used to illustrate embodiments of the invention. In the drawings:

FIG. 1 is a data flow diagram illustrating an exemplary computing device in a network automatically triggering a debug session on a second exemplary computing device in the network according to one embodiment of the invention;

FIG. 2A illustrates an exemplary automatic start network debug session condition structure according to one embodiment of the invention;

FIG. 2B illustrates an exemplary action structure according to one embodiment of the invention;

FIGS. 3A and 3B illustrate exemplary fields of an exemplary action structure according to one embodiment of the invention;

FIG. 4 illustrates an exemplary system check, an exemplary code module check, and an exemplary event library according to one embodiment of the invention.

FIG. 5 illustrates an exemplary automatic network debug manager module according to one embodiment of the invention;

FIG. 6A illustrates a first computing device indirectly triggering a debug session on a second computing device through an intermediary computing device according to one embodiment of the invention;

FIG. 6B illustrates a first computing device indirectly triggering a debug session on a second computing device through an intermediary computing device according to another embodiment of the invention;

FIG. 6C illustrates a first computing device automatically triggering a debug session on a second computing device and the second computing device automatically triggering a debug session on a third computing device according to one embodiment of the invention;

FIG. 6D illustrates a first computing device automatically triggering a debug session on a second computing device through an unintended intermediary computing device and the unintended intermediary computing device automatically starting a debug session according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The techniques shown in the figures can be implemented using code and data stored and executed on one or more electronic devices (e.g., a computer, a network element, etc.). Such electronic devices store and communicate (internally and with other computers over a network) code and data using machine-readable media, such as machine storage media (e.g., magnetic disks; optical disks; random access memory; read only memory; flash memory devices) and machine communication media (e.g., electrical, optical, acoustical or other form of propagated signals—such as carrier waves, infrared signals, digital signals, etc.). In addition, such computers typically include a set of one or more processors coupled to one or more other components, such as a storage device, a number of user input/output devices (e.g., a keyboard and a display), and a network connection. The coupling of the set of processors and other components is typically through one or more busses and bus controllers. The storage device and network connection respectively represent one or more machine storage media and machine communication media. Thus, the storage device of a given electronic device typically stores code and data for execution on the set of one or more processors of that electronic device. Of course, one or more parts of an embodiment of the invention may be implemented using different combinations of software, firmware, and/or hardware.

A method and apparatus for automatically triggering debug sessions across a network is described. In one embodiment of the invention a first code module at a first computing determines to automatically trigger a debug session on a second code module at a second computing device. The properties of the debug session are encoded into an automatic network debug message, and this automatic network debug message is sent to computing devices in the network. In another embodiment of the invention, the first computing device automatically triggers the stopping of automatically started debug session on the second computing device.

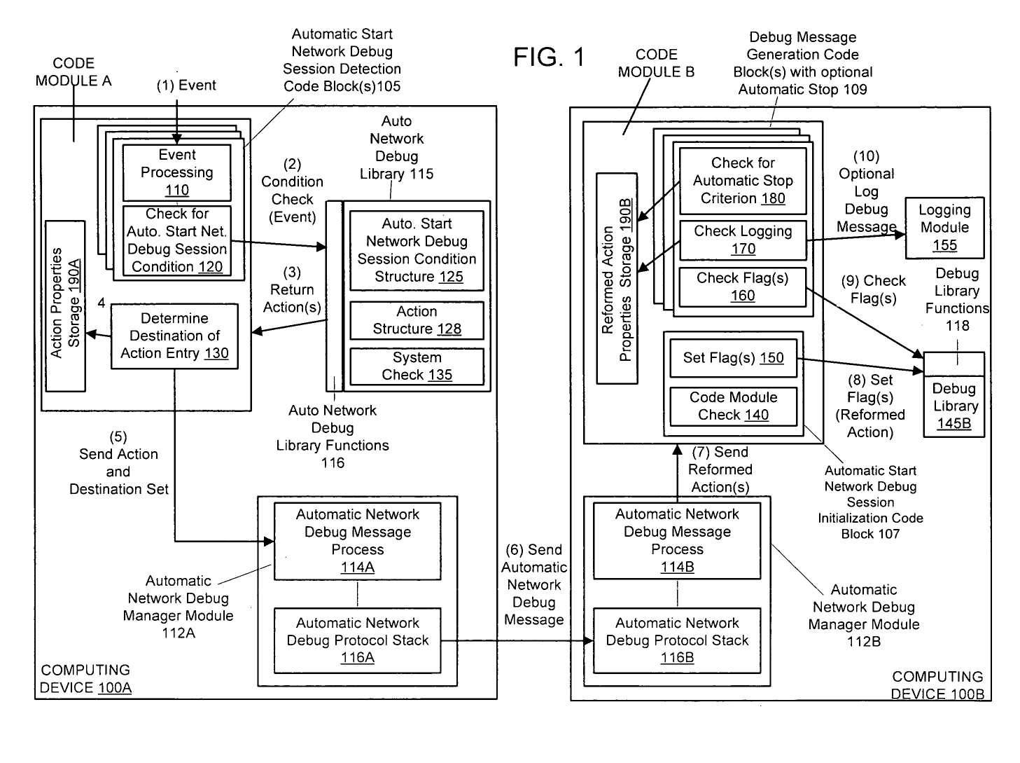

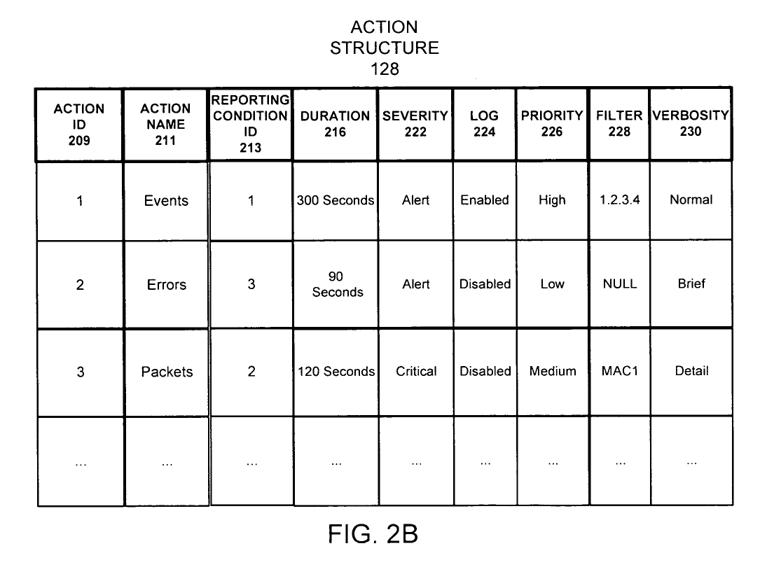

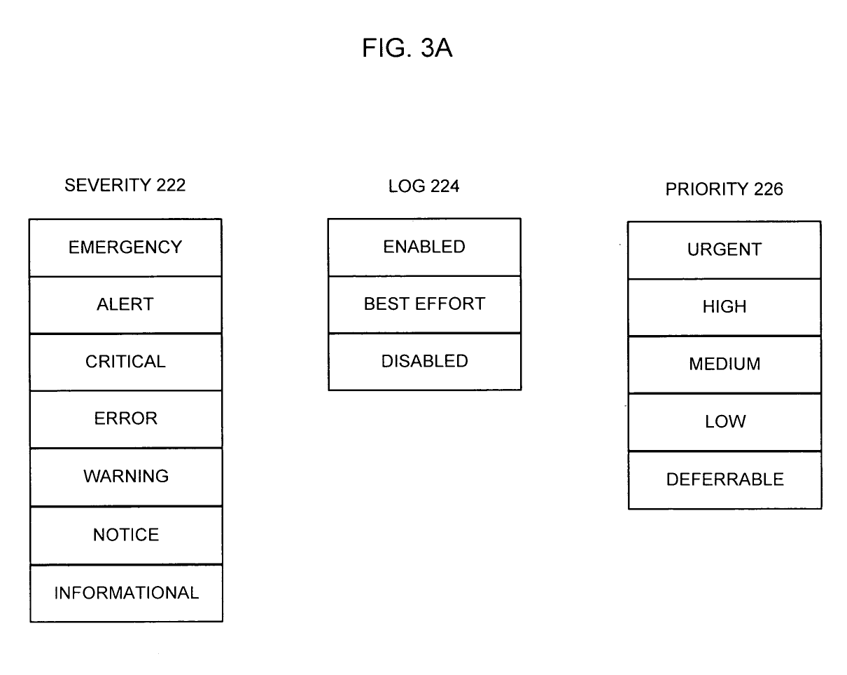

FIG. 1 is a data flow diagram illustrating an exemplary computing device in a network automatically triggering a debug session on a second exemplary computing device in the network according to one embodiment of the invention. The operations of the data flow diagram FIG. 1 will be described with reference to the exemplary embodiment of FIGS. 2A, 2B, 3A, 3B, 4 and 5. However, it should be understood that the operations of the data flow diagram FIG. 1 can be performed by embodiments of the invention other than those discussed with reference to FIGS. 2A, 2B, 3A, 3B, 4 and 5, and the embodiments discussed with reference to FIGS. 2A, 2B, 3A, 3B, 4 and 5 can perform operations different than those discussed with reference to the data flow diagram.

The computing device 100A is coupled with computing device 100B over a network according to one embodiment of the invention. According to one embodiment of the invention computing device 100A and 100B are network elements. A network element is an electronic device that provides support or services of a computer network. For example, a network element may be an intermediate device in the network (e.g., router, bridge, switch, etc.). For example, computing device 100A may be a router that exchanges routes with computing device 100B, which also may be a router. Included in computing device 100A is code module A, automatic network debug library 115, and automatic network debug manager module 112A. Included in computing device 100B is code module B, debug library 145, logging module 155, and automatic network debug manager module 112B. Code modules A and B may be any module, thread, or process in the computing device in which debug messages may be generated. As an example of a code module, in the case of a computing device being a router, a module in the router that may generate debug messages is the routing module (e.g., Routing Information Base module). Within code module A are one or more automatic start network debug session detection code blocks 105, which are interspersed throughout code module A, determine destination of action entry 130, and action properties storage 190A. Included within code module B are one or more debug message generation code blocks with optional automatic stop 109, which are interspersed throughout code module B, automatic start network debug session initialization code block 107, and reformed action properties storage 190B. Included within automatic network debug manager module 112A and 112B are automatic network debug message process 114A and 114B respectively and automatic network debug protocol stack 116A and 116B respectively (blocks labeled with “A” correspond with computing device 100A and blocks labeled with “B” correspond with computing device 100B). Details regarding each of these will be discussed with greater detail below. It should be understood that computing device 100A and 100B each have multiple code modules that are not shown for simplicity purposes in FIG. 1.

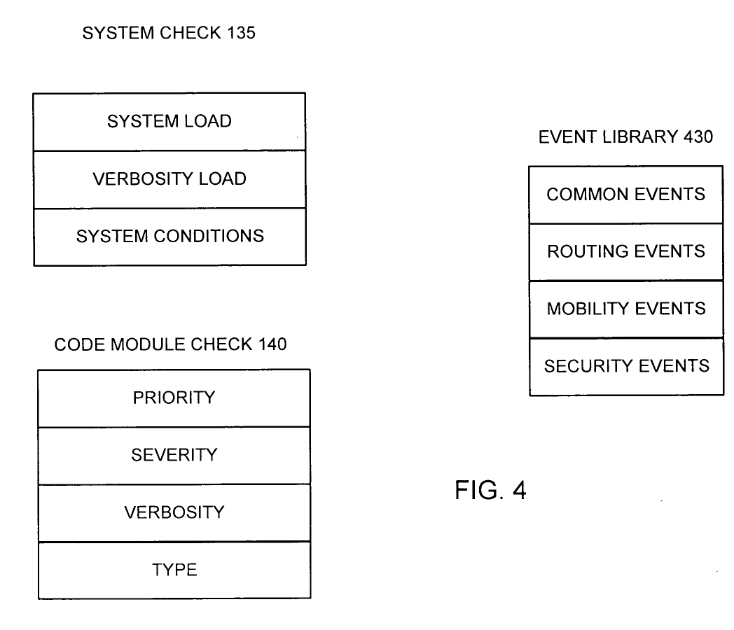

At a time 1, event processing 110, included within automatic start network debug session detection code block(s) 105, processes a detected event. The detected event is an occurrence of significance to the first code module. For example, a detected event may be any variation from normal and expected system behavior. For example an event may be an authentication failure. However, an event may also be certain routine behavior. For example, an event may occur when a user logs on to the system. According to one embodiment of the invention, events are defined in an event library (not shown in FIG. 1 for simplicity purposes). An exemplary event library is illustrated in FIG. 4 as event library 430. Included within event library 430 are common events, routing events, mobility events and security events. Common events may include events that are common to every code module in the system. Routing events, mobility events, and security events may be specific to certain code modules in the system. It should be understood that the type of events illustrated in event library 430 is illustrative and is not meant to be limiting. For example, in one embodiment of the invention event library 430 is extendable by user action. According to one embodiment of the invention, each code module registers with event library 430 the events that it supports.

As previously described, the detected event is processed at event processing 110 at a time 1. According to one embodiment of the invention event processing 110 determines whether the event is pertinent to code module A (e.g., whether code module A supports that event). For example, if the event is pertinent to code module A, code module A increases a counter for the event and passes this information to check for automatic start network debug session condition 120. Thus, code module A accounts for the number of times that that event being processed has been encountered according to one embodiment of the invention. For example, upon code module A processing an authentication failure, code module A increases the counter for the event authentication failure by one.

The event counter is passed to check for automatic start network debug session condition 120. Check for automatic start network debug session condition 120 determines if the detected event constitutes an automatic start network debug session condition. An automatic start network debug session condition is a set of one or more start criterions of which the detected event is a part. For example, an automatic start network debug session condition may include one or more events. For example, the automatic start network debug session condition authentication failure may include one or more authentication failure events. Thus check for automatic start network debug session condition 120 determines if a processed event constitutes an automatic start network debug session condition.

According to one embodiment of the invention, check for automatic start network debug session condition 120 passes the event and the count of the event to automatic network debug library 115 at a time 2. Automatic network debug library 115 contains one or more automatic network debug library functions 116 which access information stored in automatic network debug library 115. For example, check for automatic start network debug session condition 120 may call an automatic network debug library function to determine if an automatic start network debug session condition exists for the count of events (e.g., condition_check(event)). This automatic network debug library function call checks automatic start network debug session condition structure 125 to determine if an automatic start network debug session condition has been met. FIG. 2A illustrates an exemplary automatic start network debug session condition structure according to one embodiment of the invention. While in one embodiment the automatic start network debug session condition structure 125 is a table, in alternative embodiments the automatic start network debug session condition structure 125 is a different data structure (e.g., a linked list, tree, etc.). Automatic start network debug session condition structure 125, as illustrated in FIG. 2A, includes automatic start network debug session condition name 202, automatic start network debug session condition type 204, automatic start network debug session condition threshold 206, action set 208, destination set 210, and automatic start network debug session condition ID 212. The field automatic start network debug session condition name 202 is defined with one or more events. Thus in FIG. 2A, authentication failures is an automatic start network debug session condition with the automatic start network debug session condition ID of 1. Similarly, consecutive route add failures is an automatic start network debug session condition with the automatic start network debug session condition ID of 2. The field automatic start network debug session condition type 204 indicates the kind of automatic start network debug session condition a particular automatic start network debug session condition entry is. For example, in FIG. 2A, “failure” is the type of automatic start network debug session condition for automatic start network debug session condition ID 1 and 2. Other automatic start network debug session condition types may be, which can be of the types “failure”, “timeout”, “delay”, “lack of resource”, “overwhelm”, “administrative”, etc. The field automatic start network debug session condition threshold 206 denotes how many times a particular event must have been detected prior to meeting an automatic start network debug session condition. Therefore, if code module A has encountered 3 authentication failures, or 5 consecutive route add failures then an automatic start network debug session condition has been met. The field action set 208 defines one or more actions for the particular automatic start network debug session condition. For example, automatic start network debug session condition ID 1 has corresponding actions 1 and 3. Details regarding actions are discussed in greater detail below. The destination set 210 defines one or more destination computing devices for which a debug session should be triggered based on a particular automatic start network debug session condition. For example, the entry corresponding to automatic start network debug session condition ID 2 indicates that computing device B and computing device C should start a debug session. Details regarding determining the properties of the debug session are discussed in greater detail below.

If an automatic start network debug session condition has been met, internally within automatic network debug library 115 the action or actions that correspond to that automatic start network debug session condition are determined. An action defines properties of an automatic network debug session. While in one embodiment of the invention the action includes an indication of which debug messages should be generated, in alternative embodiments of the invention the action also includes whether those debug messages should be logged, when the debug session should be stopped (i.e., when the debug messages should stop being generated), whether the debug messages should be filtered, etc. Actions are defined within action structure 128 according to one embodiment of the invention. According to another embodiment of the invention, the automatic start network debug session condition structure 125 and the action structure 128 are combined into a single combined automatic start network debug session condition/action structure.

FIG. 2B illustrates an exemplary action structure according to one embodiment of the invention. While in one embodiment the action structure 128 is a table, in alternative embodiments the action structure 128 is a different data structure (e.g., a linked list, tree, etc.). An entry in the action structure (e.g., a row in action structure 128 as illustrated in FIG. 2B) defines attributes of a single action. Thus, each entry in the action structure defines the properties of a single debug session. As will be described in greater detail below, although action(s) may exist for a certain automatic start network debug session condition, a debug session is not always automatically started as a result.

According to another embodiment of the invention, check for automatic start network debug session condition 120 determines whether the detected event constitutes a automatic start network debug session condition by looking up an automatic start network debug session condition structure that is local to code module A. For example, an automatic start network debug session condition structure may exist in code module A that is private to code module A. Thus each automatic start network debug session condition that is relevant to code module A is contained within the local automatic start network debug session condition structure. Similarly, one or more actions corresponding to each automatic start network debug session condition may also be defined locally to code module A.

Triggering debug sessions is considered overhead in computing device 100A and can negatively affect the performance of computing device 100A (e.g., generating debug messages consumes system resources such as processor usage, memory usage, disk usage, etc.). Thus, according to one embodiment of the invention before action(s) are returned to code module A, a system check 135 is performed. The system check 135 determines whether the computing device 100A allows debug sessions to be triggered. Many different system checks may be performed during the system check 135. For example, one system check that may be performed is a system load check. If the system load is over a certain percentage, the computing device will not allow debug sessions to be triggered. Thus, the system load check is acting as a threshold. Similarly, other system checks may be performed during system check 135 (e.g., free memory of the computing device, the number of blocked processes, the rate of context switches, etc.).

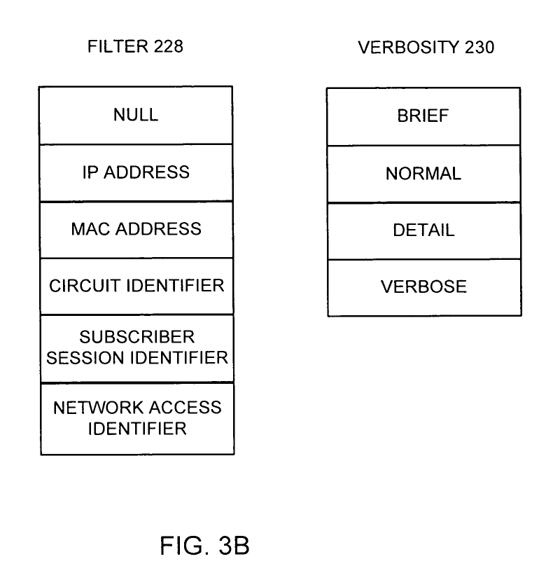

In one embodiment of the invention the system checks are performed in conjunction with certain attributes of the action. For example, the severity attribute 222 of action structure 128 as illustrated in FIG. 3A indicates the relative importance of the action. The more important the action the less value system checks are given. For example, the severity attribute 222 may be marked as emergency, which indicates that the computing device may be unusable. If the severity attribute 222 is marked as emergency, in one embodiment of the invention regardless of the results of any system checks performed debug sessions may be triggered (e.g., no matter how high the current processing load of the computing device is, the computing device allows the debug sessions to be triggered). As another example, the severity attribute may be marked as alert, which indicates that attention is needed immediately. Thus, similarly to being marked as emergency, in one embodiment of the invention the computing device 100A allows debug sessions to be triggered regardless of the results any system checks performed. The severity attribute 222 may be marked differently (e.g., critical, error, warning, notice, informational, etc.).

According to one embodiment of the invention the level of the system checks are dynamic depending on the severity attribute 222. For example, the severity attribute may be marked as critical, which indicates that the automatic start network debug session condition is critical. If the severity attribute 222 is marked as critical, each system check performed is modified so that debug sessions are allowed to be triggered except in cases of extreme system state. For example, if the automatic start network debug session condition is critical, computing device 100A may allow a debug session to be triggered unless the system load running is critically high (e.g., over 90% of its capacity). Similarly, if the severity attribute 222 is marked with error (error attributes indicate that the automatic start network debug session condition is related to an error), computing device 100A may allow a debug session to be triggered unless the system load is over 75% of total capacity. Similarly, actions marked as warning, notice, or informational have similar dynamic system checks associated with them. It should be understood that the above examples are illustrative as the above system checks may be performed differently and many other system checks may be performed.

Assuming that the system checks have been passed (i.e., the computing device allows a debug session to start) or the actions have bypassed the system checks (e.g., the severity of the action is emergency or alert), at a time 3 the action(s) are returned to code module A. The action(s) that are returned include all the information in the corresponding action entry according to one embodiment of the invention. For example, referring to FIG. 2B, if code module A has detected the automatic start network debug session condition authentication failures, the action entries associated with action ID 1 and action ID 3 are returned to code module A at a time 3. The action(s) that are received by code module A are placed into the action attributes storage 190A temporarily. Thus, referring to FIG. 2B, the attributes associated with action ID 1 and action ID 3 are stored in the action attributes storage 190A temporarily. Action attribute storage may be storage by any means known in the art (e.g., cache, RAM, hard disk, optical disk, etc.). While in one embodiment of the invention the action is stored locally relative to a code module, in alternative embodiments of the invention the actions are stored globally relative to the computing device. According to one embodiment of the invention, after the action(s) are dispatched to the appropriate computing devices according to the destination set 210, code module A resets the event counter for that corresponding event. According to another embodiment of the invention, after the action(s) are returned to code module A, code module A resets the event counter for that corresponding event.

Once the action(s) are returned, determine destination of action entry 130 determines the destination of the action(s) at a time 4. The destination indicates which computing device in the network to receive the action and start a debugging session for that action. For example referring to FIG. 2B, if code module A receives the actions associated with action ID 1 and action ID 3, the determine destination of entry 130 determines that the destination for the actions is computing device 100B. While in one embodiment of the invention the determine destination of action entry 130 accesses action attributes storage 190A to determine the destination, in alternative embodiments of the invention the determine destination of action entry 130 accesses condition structure 125 directly to determine the destination of the action.

After the destination of each of the action entries are determined, the actions are sent to their destinations. In order to send the actions across a network, the actions must be formatted in a message understandable to the destination computing devices and capable of being sent across the network. Thus, at a time 5 the action(s) and the destination set (e.g., the destinations of the actions) are transmitted to automatic network debug message process 114A included in automatic network debug manager module 112A. Actions may be sent from code module A to the automatic network debug message process 114A by any known means of communicating between processes (e.g., inter-process communication (IPC)). In one embodiment the automatic network debug library 115 maintains a list of the code modules that are capable of sending and receiving actions and the IPC endpoints of those code modules and the automatic network debug message process 114A. When a code module determines to send an action(s) to the automatic network debug message process 114A the sending code module determines the IPC endpoint of the automatic network debug message process 114A and sends the message over an IPC channel (e.g., message queue, mailbox, pipe, socket, etc.). Thus, code module A determines the IPC endpoint of the automatic network debug message process 114A and sends the action to the automatic network debug message process 114A.

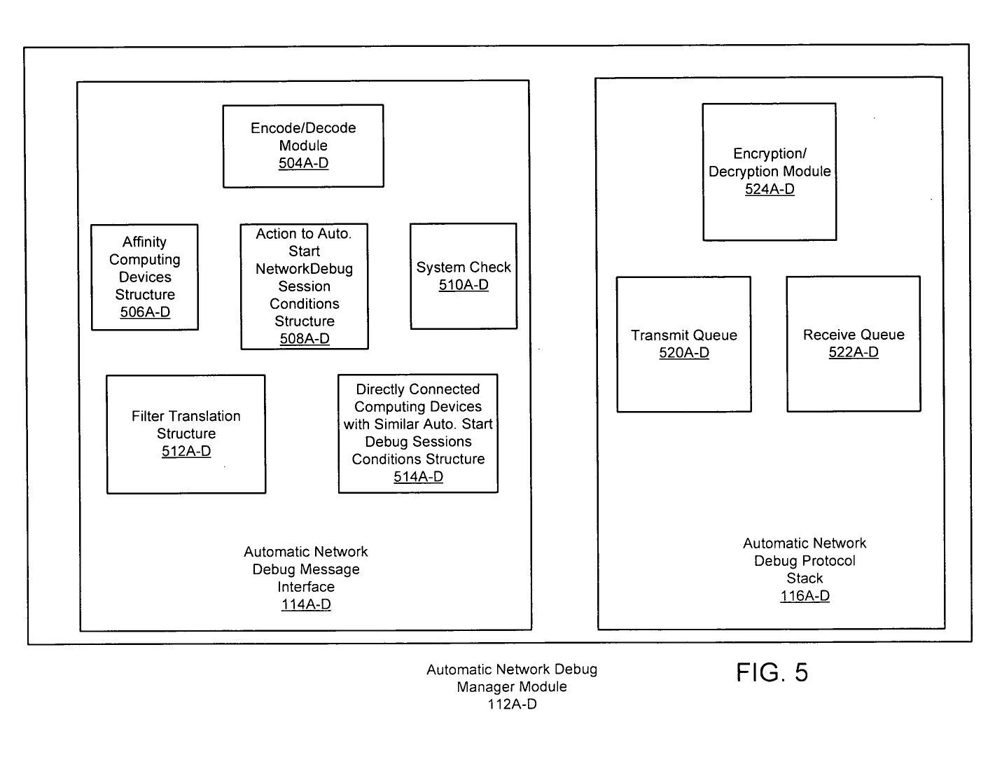

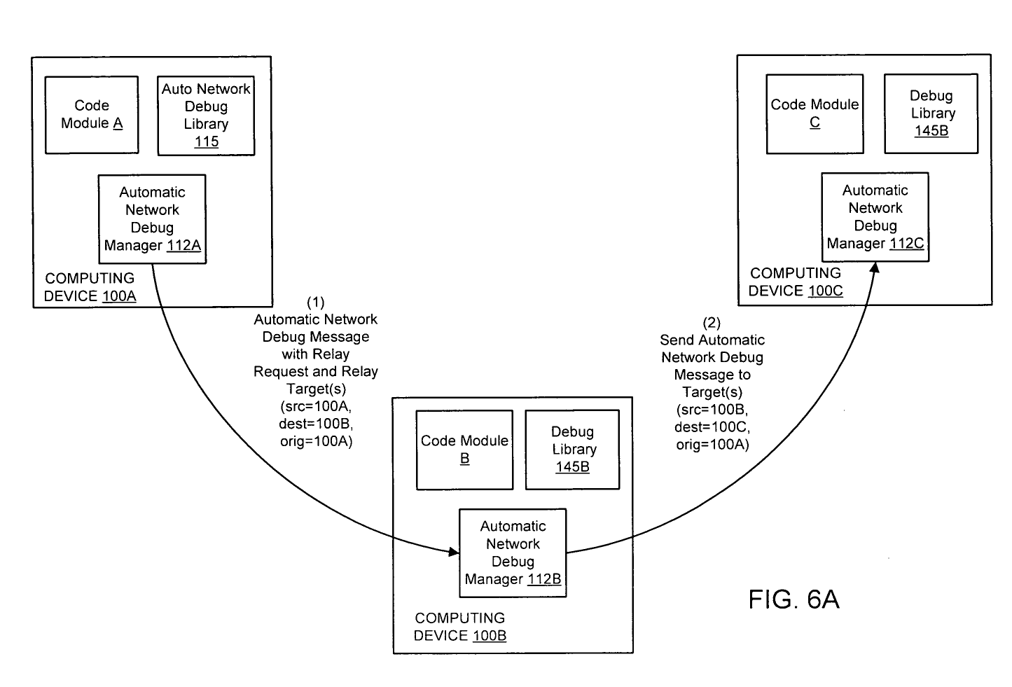

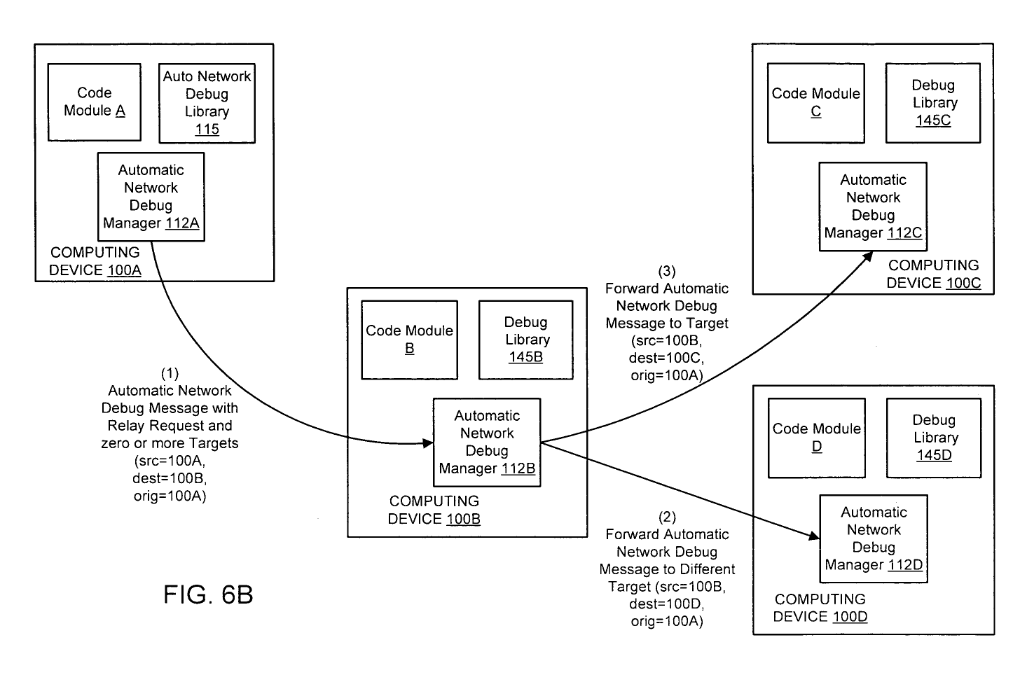

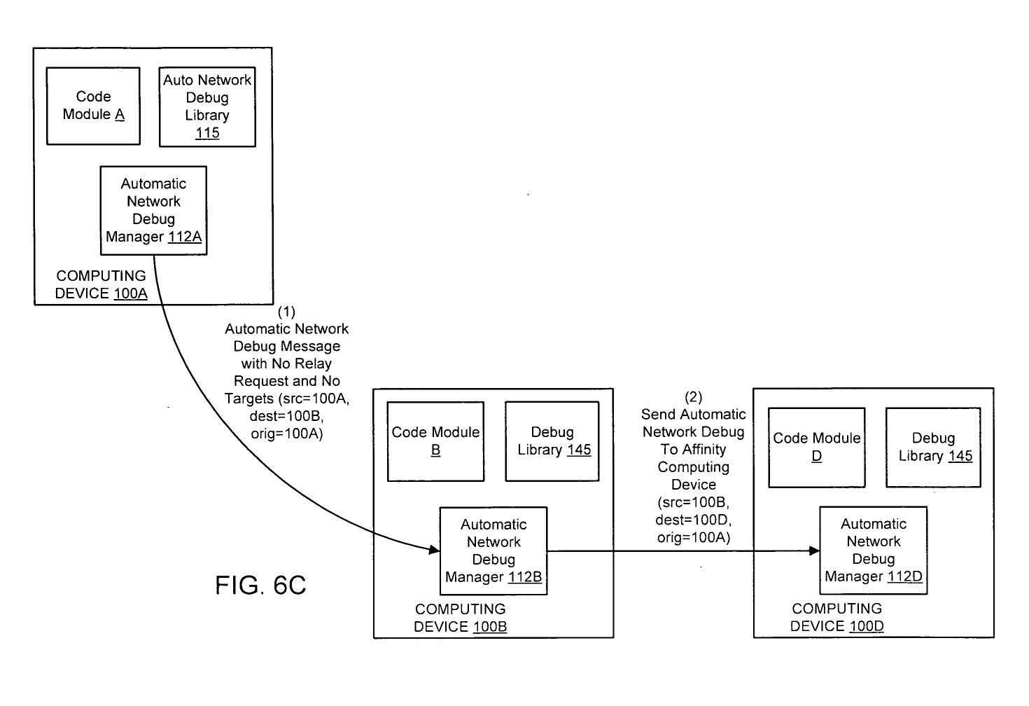

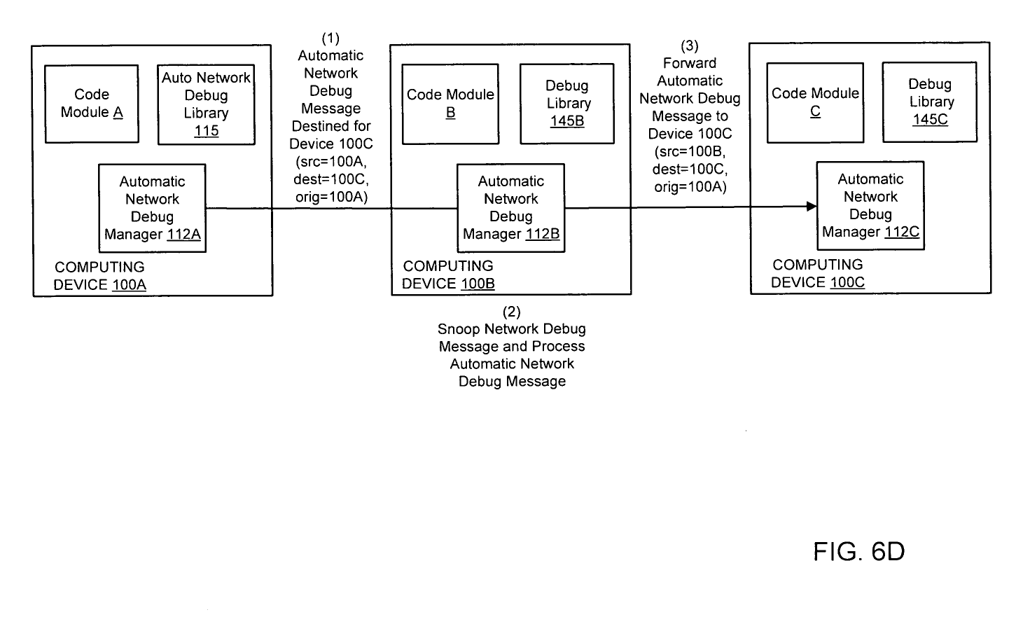

Automatic network debug message process 114A forms an automatic network debug message based on the action(s) that it receives. FIG. 5 illustrates an exemplary automatic network debug manager module 112A-D according to one embodiment of the invention, which includes an exemplary automatic network debug message process 114A and an exemplary automatic network debug protocol stack 116A. Note that FIG. 5 illustrates an exemplary automatic network debug manager module and an exemplary automatic network debug protocol stack that corresponds with computing device 100A-D. Although computing devices 100C-D are not illustrated in FIG. 1, computing devices 100C-D are discussed with reference to FIGS. 6A-6D. Included within automatic network debug message process 114A-D is encode/decode module 504A-D respectively, affinity computing devices structure 506A-D respectively, action to automatic start network debug session conditions structure 508A-D respectively, system check 510A-D respectively, filter translation structure 512A-D respectively, and directly connected computing devices with similar automatic start network debug session conditions structure 514A-D respectively. While affinity computing devices structure 506A-D, action to automatically start debug session condition structure 508A-D, filter translation structure 512A-D, and directly connected computing devices with similar automatic start network debug sessions conditions structure 514A-D are illustrated as being local to automatic network debug message interface 114A-D respectively, in alternative embodiments of the invention these structures are located in a central location in computing devices 100A-D respectively. For example, referring to FIG. 1, these structures may be included in automatic network debug library 115.

Upon receiving the action, automatic network debug message interface 114A forms an automatic network debug message according to the received action. For example, encode/decode module 504A forms the automatic network debug message from the actions received. According to one embodiment of the invention, the format of the automatic network debug message is the following:

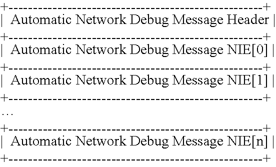

According to one embodiment of the invention, an automatic network debug message NIE (network debug information element) is a protocol and encoding independent TLV (type, length, value) description of one or more attributes of the automatic network debug message (e.g., a reporting condition, a filter, code module identifier, etc.). The automatic network debug message NIE is used to carry information pertinent to the debug session (e.g., information contained in the action). According to one embodiment of the invention, an exemplary format of an automatic network debug message NIE is the following:

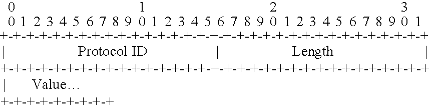

The protocol ID field of the automatic network debug message NIE identifies particular automatic network debug message NIEs.

According to one embodiment of the invention, an exemplary format of an automatic network debug message header is the following:

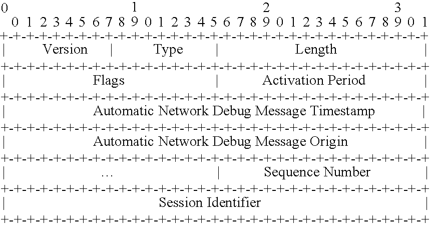

The version field of the automatic network debug message header is the current version of the automatic network debug message. The version may be set to 0x01 and incremented over time if the automatic network debug message header changes. The type field identifies the type of automatic network debug message carried by this packet. According to one embodiment of the invention the type may be marked as automatic start network debug session trigger or automatic start network debug session reply. An automatic network debug message is marked with the type of automatic start network debug session trigger when that computing device desires to automatically trigger the start of a debug session on another computing device, and an automatic network debug message is marked with the type of automatic start network debug session reply by a computing device that has previously received an automatic start network debug session trigger and is replying to that message. The length field indicates the number of bytes following the session identifier field.

The flags field may be defined as the following:

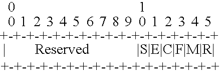

The ‘R’ flag is used to indicate whether a relay is required (e.g., whether a first computing device desires a second computing device to forward the automatic network debug message to a third computing device). The ‘R’ flag will be discussed in greater detail with reference to FIGS. 6A-6D. The ‘M’ flag is used to indicate whether the origin of the automatic network debug message is a MAC address. The ‘F’ flag applies filters included in the action to all requesting protocol NIEs (described in more detail below). If the ‘F’ flag is not set, then the filter bitmap of the filter NIE (described in more detail below) is used to determine the filters. Similarly, the ‘C’ Flag applies reporting conditions included in the action to all requesting protocol NIEs if the flag is set. If the ‘C’ flag is not set, then the reporting condition bitmap of the reporting condition NIE is used to apply reporting conditions. The ‘E’ flag indicates that each requesting protocol NIE included in the automatic network debug message has failed to start a debug session. The ‘S’ flag indicates that the automatic network debug message is encrypted.

According to one embodiment of the invention, the activation period is the number of seconds that a sending computing device (i.e., the triggering computing device) waits to receive an automatic start network debug session reply message from the receiving computing device before retransmitting the automatic start network debug session trigger. According to one embodiment of the invention, the automatic network debug message origin preserves the original source of an automatic network debug message. The automatic network debug message origin is discussed in greater detail with reference to FIGS. 6A-6D.

According to one embodiment of the invention, the sequence number field is an identifier to match particular automatic start network debug session triggers and automatic start network debug session reply messages. In one embodiment of the invention, when an automatic start network debug session trigger is received, the sequence number in that message is copied into the corresponding automatic start network debug session reply message. The session identifier is used to identify the security context for encrypted exchanges between the computing device that sends automatic start network debug session triggers and the computing device that receives those automatic start network debug session triggers.

As previously discussed, the automatic network debug message NIE is used to carry information pertinent to a debug session (e.g., information contained in the action received). While in one embodiment of the invention automatic network debug message NIEs are generic, in alternative embodiments of the invention automatic network debug message NIEs are vendor specific. For example, a vendor specific automatic network debug message NIE provides flexibility of extending the automatic network debug message payloads to include vendor specific debugging information. Generic automatic network debug message NIEs may include a filter NIE, a reporting condition NIE, a destination list NIE, a requesting protocol NIE, and a replying protocol NIE according to one embodiment of the invention. The various NIEs are identified by the following, according to one embodiment of the invention:

| | |
|---|---|
| Description | Value |

(Master NIE range 0x0001-0x000F)

| | |
|---|---|
| Vendor Specific NIE | 0x0001 |
| Filter NIE | 0x0002 |
| Condition NIE | 0x0003 |
| Address List NIE | 0x0004 |
| Any Protocol NIE | 0x0005 |
| Master Reserved | 0x0006-0x000F |

(L2 Protocol NIE range 0x0010-0x002F)

| | |
|---|---|
| GENERIC-BRIDGE NIE | 0x0010 |
| GENERIC-STP NIE | 0x0011 |
| GENERIC-L2TUNNEL NIE | 0x0012 |
| IEEE-DOT1 NIE | 0x0013 |
| IEEE-DOT1Q NIE | 0x0014 |
| IEEE-DOT11 NIE | 0x0015 |
| IEEE-DOT11S NIE | 0x0016 |
| IEEE-DOT16D NIE | 0x0017 |
| IEEE-DOT16E NIE | 0x0018 |
| QinQ NIE | 0x0019 |
| ATM NIE | 0x001A |
| FR NIE | 0x001B |
| PPP NIE | 0x001C |
| PPPoE NIE | 0x001D |
| MPLS NIE | 0x001E |
| MPLS-STATIC NIE | 0x001F |
| LDP NIE | 0x0020 |
| L2TP NIE | 0x0021 |
| VPLS NIE | 0x0022 |
| PWE3 NIE | 0x0023 |
| GENERIC-WIFI NIE | 0x0024 |
| GENENIC-WIMAX NIE | 0x0025 |
| L2 Protocol Reserved | 0x0026-0x002F |

(L3 Protocol NIE range 0x0030-0x004F)

| | |
|---|---|
| BGP NIE | 0x0030 |
| OSPF NIE | 0x0031 |
| OSPFv3 NIE | 0x0032 |
| IS-IS NIE | 0x0033 |
| RIP NIE | 0x0034 |
| Mobile-IP NIE | 0x0035 |
| Mobile-IPv6 NIE | 0x0036 |
| GENERIC-L3TUNNEL NIE | 0x0037 |
| GRE-TUNNEL NIE | 0x0038 |
| IPinIP-TUNNEL NIE | 0x0039 |
| PIM NIE | 0x003A |
| MANET-ROUTING NIE | 0x003B |
| MESH-ROUTING NIE | 0x003C |
| VRRP NIE | 0x003D |
| L3 Protocol Reserved | 0x003E-0x004F |

(L4 Protocol NIE range 0x0050-0x006F)

| | |
|---|---|
| UDP NIE | 0x0050 |
| TCP NIE | 0x0051 |
| SCTP NIE | 0x0052 |
| SIP NIE | 0x0053 |
| MGCP NIE | 0x0054 |
| L4 Protocol Reserved | 0x0055-0x006F |

(Application Protocol NIE range 0x0070-0x00AF)

| | |
|---|---|
| HTTP NIE | 0x0070 |
| HTTPS NIE | 0x0071 |
| DNS NIE | 0x0072 |
| NTP NIE | 0x0073 |
| SNMP NIE | 0x0074 |
| SMTP NIE | 0x0075 |
| NNTP NIE | 0x0076 |
| FTP NIE | 0x0077 |
| TFTP NIE | 0x0078 |
| IMAP NIE | 0x0079 |
| IRCP NIE | 0x007A |
| MIME NIE | 0x007B |
| NFS NIE | 0x007C |
| SOAP NIE | 0x007D |
| TELNET NIE | 0x007E |
| VTP NIE | 0x007F |
| Application Protocol Reserved | 0x0080-0x00AF |

(Security Protocol range 0x00B0-0x00CF)

| | |
|---|---|
| AAA NIE | 0x00B0 |
| RADIUS NIE | 0x00B1 |
| TACACS NIE | 0x00B2 |
| DIAMETER NIE | 0x00B3 |
| EAP NIE | 0x00B4 |
| TLS NIE | 0x00B5 |
| TTLS NIE | 0x00B6 |
| PEAP NIE | 0x00B7 |
| FAST NIE | 0x00B8 |
| SIM NIE | 0x00B9 |
| AKA NIE | 0x00BA |
| CHAP NIE | 0x00BB |
| GTC NIE | 0x00BC |
| IPSEC NIE | 0x00BD |
| SSL NIE | 0x00BE |
| SSH NIE | 0x00BF |
| PKI NIE | 0x00C0 |
| LI NIE | 0x00C1 |
| IDS NIE | 0x00C2 |
| IPS NIE | 0x00C3 |
| NAC NIE | 0x00C4 |
| Firewall NIE | 0x00C5 |
| Security Protocol Reserved | 0x00C6-0x00CF |

(Utility Protocol NIE range 0x00D0-0x00FF)

| | |
|---|---|
| ARP NIE | 0x00D0 |
| DHCP NIE | 0x00D1 |
| FIB NIE | 0x00D2 |
| ICMP NIE | 0x00D3 |
| IGMP NIE | 0x00D4 |
| QoS NIE | 0x00D5 |
| SYSLOG NIE | 0x00D6 |
| NAT NIE | 0x00D7 |
| PAT NIE | 0x00D8 |
| MSDP NIE | 0x00D9 |
| GSMP NIE | 0x00DA |
| IPFIX NIE | 0x00DB |
| PSAMP NIE | 0x00DC |
| CAPWAP NIE | 0x00DD |
| TE NIE | 0x00DE |
| IPv6-ND NIE | 0x00DF |
| VPN NIE | 0x00E0 |
| RSVP NIE | 0x00E1 |
| Utility Protocol Reserved | 0x00E2-0x00FF |
| Reserved | 0x0100-0xFFFF |

It should be understood that many other NIEs may be defined, thus the above list is meant to be illustrative and not limiting.

Referring back to FIG. 1, the action(s) were sent to automatic network debug message interface 114A at a time 5 from code module A. As previously described, code module A may be any module, thread, or process in the computing device in which debug messages may be generated. Similarly, in one embodiment of the invention, code module A may include more than one thread each of which are capable of triggering debug sessions. For example, if code module A is a mobile networking module, that module may include a generic WiMAX thread and a mobile IP thread each of which capable of triggering debug sessions. Thus, each of these threads may have one or more corresponding actions associated with them. In order to account for multiple actions from multiple threads (e.g., protocols), a requesting protocol NIE for each protocol is used according to one embodiment of the invention. Certain attributes of the action(s) received by automatic network debug message interface 114A are encoded into a requesting protocol NIE by automatic network debug encode/decode module 504A according to one embodiment of the invention. Requesting protocol NIEs are identified with the NIE identifiers listed above. For example, the WiMAX NIE is identified with 0x0025 and the Mobile IP NIE is identified with 0x0035. In one embodiment of the invention a requesting NIE has the following format:

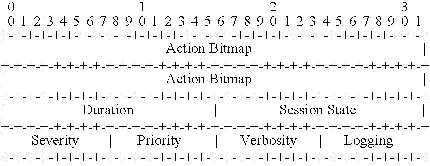

The action bitmap of the requesting protocol NIE corresponds with the action name attribute 211 (illustrated in FIG. 2A) according to one embodiment of the invention. For example, in one embodiment of the invention the action bitmap includes the following definitions:

| | |
|---|---|
| Bit 0: | NETDEBUG_EVENTS |
| Bit 1: | NETDEBUG_ERRORS |
| Bit 2: | NETDEBUG_PACKETS |
| Bit 3: | NETDEBUG_PACKETS_RX |
| Bit 4: | NETDEBUG_PACKET_TX |
| Bit 5: | NETDEBUG_PACKET_ERRORS |
| Bit 6: | NETDEBUG_REQUESTS |
| Bit 7: | NETDEBUG_RESPONSES |
| Bit 8: | NETDEBUG_ADVERTISEMENTS |
| Bit 9: | NETDEBUG_DETAILS |
| Bit 10: | NETDEBUG_WARNINGS |
| Bit 11: | NETDEBUG_STATES |
| Bit 12: | NETDEBUG_TIMERS |
| Bit 13: | NETDEBUG_QUEUES |
| Bit 14: | NETDEBUG_SESSIONS |
| Bit 15: | NETDEBUG_CONNECTIONS |
| Bit 16: | NETDEBUG_SIGNALING |
| Bit 17: | NETDEBUG_ACCOUNTING |
| Bit 18: | NETDEBUG_AUTHORIZATION |
| Bit 19: | NETDEBUG_AUTHENTICATION |
| Bit 20: | NETDEBUG_MESSAGES |
| Bit 21: | NETDEBUG_TRANSACTIONS |
| Bit 22: | NETDEBUG_CONFIGURATIONS |
| Bit 23: | NETDEBUG_USERS |
| Bit 24: | NETDEBUG_BINDINGS |
| Bit 25: | NETDEBUG_FSM |
| Bit 26: | NETDEBUG_SOCKET |
| Bit 27: | NETDEBUG_STATISTICS |
| Bit 28: | NETDEBUG_COUNTERS |
| Bit 29: | NETDEBUG_TRACE |
| Bit 30: | NETDEBUG_AGENT |
| Bit 31: | NETDEBUG_INTERFACE |
| Bit 32: | NETDEBUG_INTERNAL |
| Bit 33: | NETDEBUG_MEMORY |
| Bit 34: | NETDEBUG_TUNNEL |
| Bit 35: | NETDEBUG_PEER |
| Bit 36: | NETDEBUG_ROUTE |
| Bit 37-63: | NETDEBUG_RESERVED |

The requesting protocol NIE duration field may be derived from the duration attribute 216 defined in the action structure 128 according to one embodiment of the invention. The duration field indicates how long a particular debug session will last. Thus, the duration field may act as an automatic stop criterion that automatically stops a particular debug session. The requesting protocol NIE session state indicates what the requesting protocol (e.g., a code module in a computing device) is directing the remote computing device to do relative to the debug session. For example, the requesting protocol NIE session state may indicate that a debug session should be started (e.g., session start), a debug session should be stopped (e.g., session stop), a debug session should be suspended (e.g., session suspend), a debug session should be resumed (e.g., session resume), a session should be updated (e.g., session update), and a session should be queried (e.g., session query).

The severity attribute of the requesting protocol NIE corresponds with the severity attribute 222 of the action received by automatic network debug message interface 114A according to one embodiment of the invention. As previously described, the severity attribute indicates the relative importance of the action. For example, referring to FIG. 3A, action ID 1 has a severity attribute 222 marked as alert. The priority attribute of the requesting protocol NIE corresponds with the priority attribute 226 of the action received by automatic network debug message interface 114A according to one embodiment of the invention. The priority attribute 226 defines how quickly a debug session corresponding to the action should be started. For example, referring to FIG. 3A the priority attribute 226 may be marked as urgent (the debug session should begin immediately), high (the debug session should start as soon as possible), medium (the debug session should start soon), low (the debug session should start when possible), and deferrable (the debug session can start at a time the code module chooses). The verbosity attribute of the requesting protocol NIE corresponds with the verbosity attribute 230 of the action received by automatic network debug message interface 114A according to one embodiment of the invention. The verbosity attribute 230 defines the verbosity level of the debug message (i.e., the level of detail included in the debug message). For example, referring to FIG. 3B, the verbosity attribute 230 may be defined as brief (debug message should be as concise as possible), normal (debug message should be moderately detailed), detail (debug message should be detailed), and verbose (everything about the debug message should be generated). The logging attribute of the requesting protocol NIE corresponds with the log attribute 224 of the action received by automatic network debug message interface 114A according to one embodiment of the invention. The log attribute indicates whether logging of debug messages is enabled.

Also included within each action received by automatic network debug message interface 114A is a filter attribute 228. For example, referring to FIG. 2B, action ID 1 includes a filter for an IP address, namely 1.2.3.4. Note that it should be understood that if no filter is defined in the action received (e.g., the filter is marked as ‘null’), then according to one embodiment of the invention no filter NIE for that action is created. While in one embodiment of the invention the filter attribute is an IP address, in alternative embodiments of the invention different filters may be used (e.g., MAC address, circuit identifier, subscriber session identifier, network access identifier, null etc.). The filter indicated in the action is formed into a filter NIE by automatic network debug encode/decode module 504A. For example, in one embodiment of the invention the filter NIE format is the following:

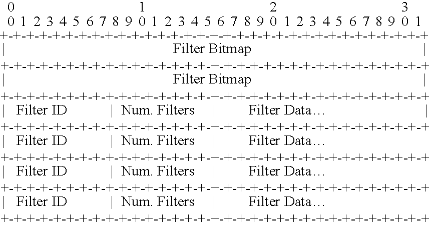

The filter bitmap defines which requesting protocol NIEs that are present in the filters should be applied to. For example, in case of multiple requesting protocol NIEs, the first bit in the filter bitmap corresponds to the first requesting protocol NIE, the second bit corresponds to the second requesting protocol NIE, and so on. The filter ID attribute of the filter NIE uniquely identifies a specific filter. According to one embodiment of the invention, the filter ID attribute may be defined as the following:

| Description | Datatype | Value |
|---|---|---|
| MAC Address | IEEE 802-3.2002 | 0x01 |
| Source MAC | IEEE 802-3.2002 | 0x02 |
| Destination MAC | IEEE 802-3.2002 | 0x03 |
| VLAN ID | IEEE 802-1Q.2003 | 0x04 |
| WLAN Channel ID | IEEE 802-11.1999 | 0x05 |
| WLAN SSID | IEEE 802-11.1999 | 0x06 |
| MPLS Label ID | RFC 3032 | 0x07 |
| ATM PVC | Standard | 0x08 |
| FR DLCI | Standard | 0x09 |
| PPP Circuit | Standard | 0x10 |
| IPv4 Address | RFC 791 | 0x1A |
| Source IPv4 | RFC 791 | 0x1B |
| Destination IPv4 | RFC 791 | 0x1C |
| Source IPv4 Prefix | RFC 791 | 0x1D |
| Destination IPv4 Prefix | RFC 791 | 0x1E |
| IPv6 Address | RFC 2460 | 0x1F |
| Source IPv6 | RFC 2460 | 0x20 |
| Destination IPv6 | RFC 2460 | 0x21 |
| Source IPv6 Prefix | RFC 2460 | 0x22 |
| Destination IPv6 Prefix | RFC 2460 | 0x23 |
| IPv6 Flow Label | Unsigned 32-bit [RFC2460] | 0x24 |
| IP DSCP | Unsigned 8-bit [RFC3260] | 0x25 |
| IP Precedence | Unsigned 8-bit [RFC3260] | 0x26 |
| IP COS | Unsigned 8-bit [RFC3260] | 0x27 |
| Transport Protocol | Unsigned 16-bit | 0x28 |
| Transport Port | Unsigned 16-bit | 0x29 |
| Source Transport Port | Unsigned 16-bit | 0x2A |
| Destination Transport Port | Unsigned 16-bit | 0x2B |
| UDP Source Port | Unsigned 16-bit [RFC768] | 0x2C |
| UDP Destination Port | Unsigned 16-bit [RFC768] | 0x2D |
| TCP Source Port | Unsigned 16-bit [RFC793] | 0x2E |
| TCP Destination Port | Unsigned 16-bit [RFC793] | 0x2F |
| BGP Source AS | RFC 4271/1930 | 0x30 |
| BGP Destination AS | RFC 4271/1930 | 0x31 |
| Username | Variable String | 0x32 |
| Hostname | Variable String | 0x33 |
| Linecard Id | Unsigned 32-bit | 0x34 |
| Port Id | Unsigned 32-bit | 0x35 |
| Ingress Interface | RFC 2863 ifIndex | 0x36 |
| Egress Interface | RFC 2863 ifIndex | 0x37 |
| Packet Type | Unsigned 64-bit | 0x38 |
| Reserved | For future use | 0x39-0xFF |

Thus, the filter attribute associated with action ID 1, IP address 1.2.3.4, would have a value of 0x1A according to one embodiment of the invention. The number of filters attribute of the filter NIE format specifies the number of filters present for a particular filter identifier. For example, in the case of a fixed-size filter (e.g., IPv4), multiple filters of the same type can be encoded under a single filter ID. For example, the filter ID that corresponds to IPv4 Address (0x1A) may include multiple IP addresses (e.g., 1.2.3.4 and 1.2.2.4) and the number of filters attribute identifies this. In the case of variable-sized filter (e.g., username), a single filter corresponds to a single filter ID, and the number of filters attribute specifies the length of the filter.

As an example of a filter, the filter NIE may include a packet type filter (e.g., filter ID 0x38). According to one embodiment of the invention the packet type filter may be represented as the following bitmap:

| Bit 0: | NETDEBUG_PACKET_TYPE_ETHERNET_MULTICAST |
|---|---|
| Bit 1: | NETDEBUG_PACKET_TYPE_IPv4_MULTICAST |
| Bit 2: | NETDEBUG_PACKET_TYPE_IPv6_MULTICAST |
| Bit 3: | NETDEBUG_PACKET_TYPE_MPLS_TOP_TE |
| Bit 4: | NETDEBUG_PACKET_TYPE_MPLS_TOP_PWE3 |
| Bit 5: | NETDEBUG_PACKET_TYPE_MPLS_TOP_VPN |
| Bit 6: | NETDEBUG_PACKET_TYPE_MPLS_TOP_BGP |
| Bit 7: | NETDEBUG_PACKET_TYPE_MPLS_TOP_LDP |
| Bit 8: | NETDEBUG_PACKET_TYPE_ATM |
| Bit 9: | NETDEBUG_PACKET_TYPE_FR |
| Bit 10: | NETDEBUG_PACKET_TYPE_MPLS |
| Bit 11: | NETDEBUG_PACKET_TYPE_L2TP |
| Bit 12: | NETDEBUG_PACKET_TYPE_WIFI |
| Bit 13: | NETDEBUG_PACKET_TYPE_WIMAX |
| Bit 14: | NETDEBUG_PACKET_TYPE_L2TUNNEL |
| Bit 15: | NETDEBUG_PACKET_TYPE_MIP_REGISTRATION |
| Bit 16: | NETDEBUG_PACKET_TYPE_MIP_ADVERTISEMENT |
| Bit 17: | NETDEBUG_PACKET_TYPE_GRE_TUNNEL |
| Bit 18: | NETDEBUG_PACKET_TYPE_L3TUNNEL |
| Bit 19: | NETDEBUG_PACKET_TYPE_TCP |
| Bit 20: | NETDEBUG_PACKET_TYPE_UDP |
| Bit 21: | NETDEBUG_PACKET_TYPE_SCTP |
| Bit 22: | NETDEBUG_PACKET_TYPE_SIP |
| Bit 23: | NETDEBUG_PACKET_TYPE_MGCP |
| Bit 24: | NETDEBUG_PACKET_TYPE_HTTP |
| Bit 25: | NETDEBUG_PACKET_TYPE_DNS |
| Bit 26: | NETDEBUG_PACKET_TYPE_NTP |
| Bit 27: | NETDEBUG_PACKET_TYPE_SNMP |
| Bit 28: | NETDEBUG_PACKET_TYPE_SMTP |
| Bit 29: | NETDEBUG_PACKET_TYPE_NNTP |
| Bit 30: | NETDEBUG_PACKET_TYPE_FTP |
| Bit 31: | NETDEBUG_PACKET_TYPE_AAA |
| Bit 32: | NETDEBUG_PACKET_TYPE_EAP |
| Bit 33: | NETDEBUG_PACKET_TYPE_ARP |
| Bit 34: | NETDEBUG_PACKET_TYPE_ICMP |
| Bit 35: | NETDEBUG_PACKET_TYPE_IGMP |
| Bit 36: | NETDEBUG_PACKET_TYPE_DHCP |
| Bit 37: | NETDEBUG_PACKET_TYPE_CAPWAP |
| Bit | NETDEBUG_PACKET_TYPE_RESERVED |
| 38-63: | |

As previously described, a vendor specific filter NIE may be defined to allow a vendor to specify a filter. For example, a vendor specific filter NIE may take the following format:

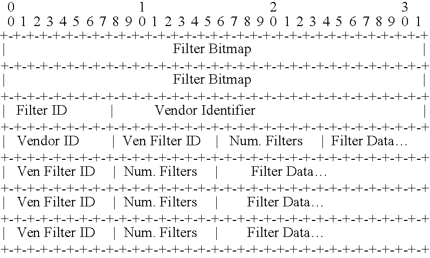

Also included within each action received by automatic network debug message interface 114A is a reporting condition ID attribute 213. For example, referring to FIG. 2B, action ID 1 includes a reporting condition ID of 1. Thus, action ID 1 indicates that debug messages that are generated by the remote computing device should be limited to items meeting the reporting condition associated with 1. The reporting condition indicated in the action(s) are formed into a reporting condition NIE by automatic network debug encode/decode module 504A. For example, in one embodiment of the invention the reporting condition NIE format is the following:

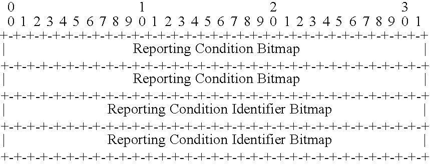

Similarly to the filter bitmap in the filter NIE, the reporting condition bitmap in the reporting condition NIE defines which requesting protocol NIEs that are present the reporting condition should be applied to. For example, in the case of multiple requesting protocol NIEs, the first bit in the reporting condition bitmap corresponds to the first requesting protocol NIE, the second bit in the reporting condition bitmap corresponds to the second requesting protocol NIE, and so on. The reporting condition identifier bitmap defines specific reporting conditions which should be applied during a debug session. According to one embodiment of the invention, reporting condition ID attribute 213 of an action should correspond with the reporting condition identifier bitmap in the reporting condition NIE. For example, the reporting condition ID bitmap may be defined as the following:

| | |
|---|---|
| Bit 0: | REPORTING_CONDITION_EXCESSIVE_AUTH_FAILURES |
| Bit 1: | REPORTING_CONDITION_EXCESSIVE_PACKET_DROPS |
| Bit 2: | REPORTING_CONDITION_EXCESSIVE_ROUTING_UPDATE_MISSES |
| Bit 3: | REPORTING_CONDITION_EXCESSIVE_TCP_HALF_CONNECTIONS |
| Bit 4: | REPORTING_CONDITION_TCP_SYN_FLOODS |
| Bit 5: | REPORTING_CONDITION_EXCESSIVE_MALFORMED_PACKETS |
| Bit 6: | REPORTING_CONDITION_EXCESSIVE_WARNINGS |
| Bit 7: | REPORTING_CONDITION_EXCESSIVE_SNMP_TRAPS |
| Bit 8: | REPORTING_CONDITION_EXCESSIVE_SNMP_ALARMS |
| Bit 9: | REPORTING_CONDITION_EXCESSIVE_RETRIES |
| Bit 11: | REPORTING_CONDITION_EXCESSIVE_RETRANSMISSIONS |
| Bit 12: | REPORTING_CONDITION_EXCESSIVE_TIMEOUTS |
| Bit 13: | REPORTING_CONDITION_EXCESSIVE_ECHO_MISSES |
| Bit 14: | REPORTING_CONDITION_EXCESSIVE_LINK_FAILURES |
| Bit 15: | REPORTING_CONDITION_EXCESSIVE_SOFTWARE_ERRORS |
| Bit 16: | REPORTING_CONDITION_EXCESSIVE_LOGOUTS |
| Bit 17: | REPORTING_CONDITION_EXCESSIVE_INTERFACE_FLAPPING |
| Bit 18: | REPORTING_CONDITION_EXCESSIVE_SESSION_DROPS |
| Bit 19-63: | REPORTING_CONDITION_RESERVED |

Thus, referring to FIG. 2B, action ID 1 has a reporting condition ID of 1 which corresponds to excessive packet drops in the reporting condition ID bitmap. Thus, action ID 1 is indicating that the debug session corresponding with action ID 1 should generate debug messages only upon the condition excessive packet drops is met. According to one embodiment of the invention, the computing device which is to receive the action (i.e., the computing device that is the destination of the action) determines the interpretations of the reporting conditions. For example, the computing device which is to receive the action may interpret excessive packet drops as 5 consecutive packet drops. In an alternative embodiment of the invention, the computing device that is sending the action (i.e., the computing device that is triggering the start of a debug session on another computing device) also sends a suggestion of the interpretation of the reporting conditions. For example, the triggering computing device may also include a field indicating that excessive packet drops is met if there are 3 consecutive packet drops.

As actions are being sent to remote computing devices, in certain circumstances the filter attribute in the message needs to be modified for the remote computing device. For example, referring to FIG. 1, if computing device 100A is a switch and computing device 100B is a gateway router, a filter based on MAC address of a user (e.g., Layer 2) is not likely to be applicable to the gateway router as the gateway router is configured to handle IP addresses (e.g., Layer 3). Thus, according to one embodiment of the invention automatic network debug manager module 112A may cause a translation of a MAC address filter for a particular user to an IP address for that same user before encoding the filter NIE if the destination computing device cannot handle the original filter. According to one embodiment of the invention, each module registers with the automatic network debug message interface of the filters it can support. For example, referring to FIG. 1, code module A registers the filters it can support with the automatic network debug message interface 114A, and code module B registers the filters it can support with the automatic network debug message interface 114B. Referring to FIG. 5, in order to perform the filter translation, a filter translation structure 512A is maintained by automatic network debug message interface 114A. According to another embodiment of the invention, the automatic network debug manager module 112B of the destination computing device 100B may translate the filter contained in the Filter NIE. While in one embodiment the filter translation structure 512A is a table, in alternative embodiments the filter translation structure 512A is a different data structure (e.g., a linked list, tree, etc.). While in one embodiment of the invention the filter translation structure is local to network debug message interface 114A, in alternative embodiments of the invention the filter translation structure is central in computing device 100A (e.g., such as part of automatic network debug library 115).

The filter translation structure 512A contains all possible combinations of the filters which are translatable. For example, the filter translation structure 512A may include a different segment containing each different translation mapping that is possible. For example, in the case of translating from IP address to a MAC address (or a MAC address to an IP address), the filter translation structure 512A includes a segment for the IP address and the MAC address. The segments containing the translation of IP address and MAC address may be populated through the use of an Address Resolution Protocol (ARP) process or alternatively through an adjacency table. For example, if computing device 100A is a switch, then it is likely that the switch already maintains an ARP table, which can be used to populate the filter translation structure 512A. Thus, automatic network debug message interface 114A, by using the filter translation structure, may translate the filter into an appropriate filter that the destination computing device may understand.

As another example, if computing device 100A is a wireless access point that is sending a service set identifier (SSID) filter to a computing device 100B, which is a switch where only certain subset of modules understand SSID (e.g., radio management or security), a translation is required in order to apply the filter to other modules (e.g., a translation to a virtual local area network ID (VLAN ID) for bridging modules). The filter translation structure 512A may include a segment for a VLAN ID and a SSID translation. This segment may be populated through the use of a wireless local area network (WLAN) process. As the computing device 100A may not know which modules in computing device 100B cannot understand the SSID filter, the computing device 100B performs the translation after it has received the automatic network debug message that includes the filter NIE. For example, after receipt of the automatic network debug message, automatic network debug message interface 114B of computing device 100B determines the destination modules that correspond with a filter and determines whether that destination module supports that filter (e.g., by checking the registered filters for that module) If the destination module does not support that filter, then automatic network debug message interface 114B checks the filter translation structure to determine if a filter translation is appropriate. For example, referring to FIG. 1, if code module A sends an action containing a SSID filter, and this SSID is encoded into a filter NIE and sent to computing device 100B through use of an automatic network debug message, and computing device 100B determines that code module B is the destination module, automatic network debug message interface 114B determines whether code module B can understand a SSID filter. In the case that code module B is a bridging module, a translation from SSID to VLAN ID is likely required. As another example, the filter translation structure 512A may include a segment for a multiprotocol label switching (MPLS) Label and frame relay data link connection identifier (FR DLCI). This segment may be populated through the use of a pseudo-wire (PW) process.

According to one embodiment of the invention, the filter translation structure 512A is updated concurrently with other data structures relating to translations. For example, the filter translation structure 512A may be updated as soon as an ARP table is updated. According to another embodiment of the invention, the filter translation structure 512A is updated on demand. For example, the automatic network debug message interface 114A of computing device 100A queries other data structures relating to translations when translation data is needed. Thus, using the above example, the automatic network debug message interface 114A causes the filter translation structure 512A to be updated only upon determining that a translation is required.

As previously discussed, the actions are destined for one or more remote computing devices. Referring to FIG. 2A, upon determining that the automatic start network debug session condition authentication failures is met; action ID 1 and action ID 3 are sent from computing device 100A to computing device 100B. Upon determining that the automatic start network debug session condition consecutive route add failures is met action ID 2 and action ID 3 are both sent to computing device 100B and computing device 100C from computing device 100A.

Referring back to FIG. 1, after automatic network debug message interface 114A forms the automatic network debug message, the automatic network debug message interface 114A places the automatic network debug message onto a transmit queue 520A within automatic network debug protocol stack 116A. Automatic network debug protocol stack 116A forms a UDP message and sends the automatic network debug message to computing device 100B at a time 6. In one embodiment of the invention the automatic network debug message is encrypted by an encryption/decryption module 524A within automatic network debug protocol stack 116A. The session identifier field of the automatic network debug message header may not only act as a unique identifier of the session, but also may be used for deriving encryption keys. For example, a triggering computing device that has decided to encrypt the automatic network debug message may use the session identifier field in order to generate an initialization vector (IV) (key). The receiving computing device reads the session identifier field from the automatic network debug message header and generates the same IV (key).

Automatic network debug protocol stack 116B receives the automatic network debug message and places it onto a receive queue 522B. If the automatic network debug message was encrypted, the message must be decrypted by encryption/decryption module 524B within automatic network debug protocol stack 116B. Automatic network debug message interface 114B reads the automatic network debug message from the receive queue and process the automatic network debug message.

Automatic network debug message interface 114B process the automatic network debug message and reforms one or more actions based on the automatic network debug message. The automatic network debug interface 114B determines whether the automatic network debug message is destined for computing device 100B. If the message is destined for computing device 100B, the automatic network debug interface 114B decodes the message and reforms one or more actions from the message. According to one embodiment, a reformed action is substantially similar to the original action that was encoded in the automatic network debug message. For example, a reformed action may include a reporting condition ID attribute (derived from the condition NIE in the automatic network debug message), a duration attribute (derived from the requesting protocol NIE), a severity attribute (derived from the requesting protocol NIE), a log attribute (derived from the requesting protocol NIE), a priority attribute (derived from the requesting protocol NIE), a filter attribute (derived from the filter NIE), and a verbosity attribute (derived from the requesting protocol NIE). The reformed action may also include information not derived from the automatic network debug message according to one embodiment of the invention. For example, the automatic network debug message interface 114B may additionally add an interrupt attribute to the reformed action which indicates whether the debug session corresponding with the action can be interrupted (e.g., stopped) by a user (e.g., whether a network administrator can manually stop the debug session). As another example, the automatic network debug message interface 114B may additionally add a counter attribute to the reformed action which limits the number of debug messages that can be generated during the debug session. Additionally, the automatic network debug message interface 114B may determine which flags in the debug library 145 should be set based on the reporting condition ID attribute and the filter attribute, and include an indication of which flags should be set in the reformed action. Setting debug flag(s) allows debug messages to be generated (e.g., once a debug flag is set the code corresponding to that debug flag is capable of generating debug messages).

The automatic network debug interface 114B determines which code modules in computing device 100B are to receive the one or more actions included in the automatic network debug message. According to one embodiment of the invention, the code module(s) that are to receive the action(s) are identified with use of the automatic network debug message NIE protocol ID encoded within the automatic network debug message. For example, if the automatic network debug message NIE protocol ID indicates that the action was originally received from a mobile IP code module, computing device 100B will send the action corresponding to that protocol ID to the mobile IP code module on computing device 100B.

Generating debug messages is considered overhead in computing device 100B and can negatively affect the performance of computing device 100B (e.g., generating debug messages consumes system resources such as processor usage, memory usage, disk usage, etc.). Thus, according to one embodiment of the invention, prior to sending the reformed action(s) to the appropriate code module(s), the automatic network debug interface 114B performs a system check to determine if computing device 100B allows a debug session to start. For example, referring to FIG. 5, automatic network debug interface 114B may perform system check 510B. Many different system checks may be performed during the system check 510B. For example, one system check that may be performed is a system load check. If the system load is over a certain percentage, the computing device will not allow debug messages to be generated. Thus, the system load check is acting as a threshold. Similarly, other system checks may be performed during system check 510B (e.g., free memory of the computing device, the number of blocked processes, the rate of context switches, etc.).

In one embodiment of the invention the system checks are performed in conjunction with certain attributes of the action. For example, as previously described, the severity attribute in the reformed action indicates the relative importance of the reformed action. The more important the reformed action the less value system checks are given. For example, the severity attribute may be marked as emergency, which indicates that the computing device may be unusable. If the severity attribute is marked as emergency, in one embodiment of the invention regardless of the results of any system checks performed the debug session may be allowed to start (e.g., no matter how high the current processing load of the computing device is, the computing device allows the debug session to start). As another example, the severity attribute may be marked as alert, which indicates that attention is needed immediately. Thus, similarly to being marked as emergency, in one embodiment of the invention the computing device 100B allows the debug session to start regardless of the results any system checks performed. The severity attribute may be marked differently (e.g., critical, error, warning, notice, informational, etc.).

According to one embodiment of the invention the level of the system checks are dynamic depending on the severity attribute. For example, the severity attribute may be marked as critical, which indicates that the automatic start network debug session condition is critical. If the severity attribute is marked as critical, each system check performed is modified so that debug sessions are allowed to start except in cases of extreme system state. For example, severity attribute is marked as critical, computing device 100B may allow a debug session to start unless the system load running is critically high (e.g., over 90% of its capacity). Similarly, if the severity attribute is marked with error (error attributes indicate that the automatic start network debug session condition is related to an error), computing device 100B may allow a debug session to start unless the system load is over 75% of total capacity. Similarly, actions marked as warning, notice, or informational have similar dynamic system checks associated with them. It should be understood that the above examples are illustrative as the above system checks may be performed differently and many other system checks may be performed.

Assuming that the system checks have been passed (i.e., the computing device allows a debug session to start) or the actions have bypassed the system checks (e.g., the severity of the action is emergency or alert), at a time 7 the action(s) are sent to the appropriate code module(s). Referring to FIG. 1, reformed action(s) are sent to code module B. The action(s) that are received by code module B are placed into the reformed action attributes storage 190B temporarily. Action attribute storage may be storage by any means known in the art (e.g., cache, RAM, hard disk, optical disk, etc.). While in one embodiment of the invention the action is stored locally relative to a code module, in alternative embodiments of the invention the actions are stored globally relative to the computing device.

As previously mentioned, generating debug messages is considered overhead as generating debug messages is not the primary function of the computing device. In addition to affecting the performance of computing device 100B as a whole, generating debug messages may also affect the performance of particular code modules. Thus it is possible that the computing device as a whole supports the start of a debug session (e.g., the system checks have passed) but the code module does not have the necessary resources to support the debug session. For example, if the code module B is a RIB module (e.g., a module that manages routing information in a router) generating debug messages may affect the rate at which the RIB module can add or update routes in a routing table. According to one embodiment of the invention, before the debug session is started each code module that has received a reformed action performs a code module check. Referring to FIG. 1, code module B performs the code module check 140. The code module B may disregard the action depending on the code module check 140 or the code module B may disregard and/or modify certain attributes in the actions depending on the code module check 140.

In one embodiment of the invention, the code module check 140 is performed by matching particular attributes of the received action against a local code module profile. For example, code module B has a profile that can be used to perform the code module check 140. While in one embodiment of the invention the code module profile is configured statically (i.e., the code module profile does not change), in alternative embodiments of the invention the code module profile is dynamically configured based on the system state (e.g., processing load, memory load, disk load, etc.). As an example, a local code module profile includes information corresponding to particular attributes of the reformed action.

According to one embodiment of the invention, the local code module profile includes information corresponding to the severity attribute, the priority attribute, and the verbosity attribute included within the reformed action. As an example, the local code module profile is configured to disregard an action (thus preventing the debug messages to be generated) unless the severity attribute in the action is marked as emergency, alert, or critical.

According to one embodiment of the invention, the profile may modify or ignore the verbosity attribute included in the reformed action. The verbosity attribute defines the verbosity level of the debug message (i.e., the level of detail included in the debug message). For example, the verbosity attribute may be defined as brief (debug message should be as concise as possible), normal (debug message should be moderately detailed), detail (debug message should be detailed), and verbose (everything about the debug message should be generated). The profile may be configured to ignore the verbosity level defined in the reformed action if the verbosity level of the reformed action is greater than the verbosity level defined in the profile. For example, the profile may be configured to ignore the verbosity level defined in the reformed action if the verbosity attribute is marked as detail or verbose. According to one embodiment of the invention, when the verbosity level included in the reformed action is ignored the verbosity attribute defined in the profile is used and processing of the reformed action is continued. Additionally the profile may be configured to honor the verbosity level in the reformed action regardless of the verbosity attribute defined in the profile depending on the severity attribute. For example, if the severity attribute is marked as emergency, alert, or critical, the profile may be configured to honor the verbosity level regardless of the verbosity level included in the reformed action.

According to another embodiment of the invention, the profile is configured to modify or ignore the priority attribute included with the reformed action according to one embodiment of the invention. The priority attribute defines how quickly a debug session corresponding to the reformed action should be started. For example, the priority attribute may be marked as urgent (the debug session should begin immediately), high (the debug session should start as soon as possible), medium (the debug session should start soon), low (the debug session should start when possible), and deferrable (the debug session can start at a time the code module chooses). The profile may be configured to ignore the action if the priority attribute included within that action is medium, low, or deferrable according to one embodiment of the invention. Alternatively, the profile may be configured to ignore the priority attribute and start the debug session according to an attribute stored in the profile.

According to another embodiment of the invention, the profile is configured to modify or ignore the reformed action based on the type of the reformed action received. For example, if a code module handles routing, the profile for the code module may be configured to modify or ignore a reformed action that is not related to routing. While certain embodiments of the invention have been described regarding the configuration of the profile, those of skill in the art will recognize that the profile configuration is not limited to the embodiments described. Thus the description of the profile is to be regarded as illustrative instead of limiting.

Thus, it should be understood that the system check and the code module check each adds dynamicity to debugging techniques by allowing the computing device to determine whether to generate debug messages based on system status, and by allowing individual code modules to determine whether to generate debug messages based on their status or preference. As generating debug messages is overhead and can affect the performance of a system, adding dynamicity allows debug messages to be generated automatically while ensuring that the system and the specific code module are capable of supporting the additional overhead caused by generating debug messages during the debug session.

Referring back to FIG. 1, after the code module check 140 has been processed and the debug session is allowed to continue, set flag(s) 150 is performed. Set Flag(s) 150 sets the flags as indicated in the reformed action. According to one embodiment of the invention the flags are set in a debug library 145B with the use of debug library functions 118. For example, at a time 8 the flags in debug library 145B are set according to the reformed action(s) received by code module B. Setting debug flag(s) allows debug messages to be generated (e.g., once a debug flag is set the code corresponding to that debug flag is capable of generating debug messages). Thus, upon setting the debug flag the debug session can be considered to be started. Note that setting debug flags is a prior art technique that also occurs when a network administrator manually starts a debug session. Therefore, a debug session has begun for code module B corresponding to the reformed action received by code module B.

Thus, a first computing device has automatically triggered a debug session to automatically start (i.e., without user action) on a second computing device across a network. The first computing device detected one or more events constituting an automatic start network debug condition at a first code module and that first code module has triggered a code module on a different computing device to automatically start a debug session. Additionally, the system checks and code module checks ensure that the computing device and the specific code module are capable of supporting the additional overhead caused by generating debug messages during the debug session. Thus, debug sessions are automatically triggered to start in a dynamic yet controlled manner within a network. Therefore, relevant debug sessions are automatically started and pertinent debug messages are generated relative to an automatically detected automatic start network debug session condition thus providing a user (e.g., network administrator) with focused debug messages from various code modules from various computing devices with the intent to guide the user to the problem causing the automatic start network debug session condition. Thus, a problem that is rarely encountered (e.g., not expected and a solution is unknown) may be evidenced in debug messages generated by one or more code modules at one or more computing devices during one or more debug sessions that were automatically started and a user (e.g., network administrator) may use those debug messages in an attempt to locate the problem and determine the solution.

Automatically triggering the start of debug sessions on multiple code modules across multiple computing devices, as opposed to manually starting debug sessions on each code module on each computing device, decreases the intelligence required to perform network debugging. For example, in the case of troubleshooting a problem, previously a network administrator must manually start a debug session and manually define the debug session at each code module in each computing device in which the network administrator believes is relevant to the problem. In contrast, automatically triggering the start of debug sessions, based on a detected automatic start network debug session condition at a first code module at a first computing device, at one or more code modules on one or more different computing devices according to the action(s) for the detected automatic start network debug session condition allows debug messages to be generated across multiple code modules on multiple computing devices automatically as a result of that detected automatic start network debug session condition. Thus, a computing device configured to participate in automatic network debugging includes the intelligence to automatically trigger the start of debug sessions on different computing devices, and the intelligence to automatically start debug sessions based on automatic network debug messages received from the different computing devices.

Furthermore, automatically triggering the start of debug sessions allows debug messages to be generated substantially soon after a problem has occurred (e.g., after an automatic start network debug session condition has been detected). In contrast, previously a network administrator must first determine that there is a problem before the network administrator can manually start any debug sessions. Thus, a network administrator previously had to realize that there is a problem in the network, and predict which computing device is experiencing the problem before manually starting a debug session. Automatically triggering the start of one or more debug sessions at various code modules on various computing devices based on a detected automatic start network debug session condition may provide early indication of malicious activities (e.g., denial of service attacks) as debug messages may be generated soon after the malicious activity has begun. Furthermore, in the case of a rare problem (i.e., a problem infrequently encountered), a network administrator may not ever know that a problem is occurring (or has occurred) if debug messages related to that problem are not generated. Thus, a computing device configured to automatically trigger the start of debug sessions may automatically trigger the generation of debug messages relevant to that rare problem allowing the network administrator to identify and resolve that rare problem.

According to one embodiment of the invention, automatic network debug message interface 114B generates a reply message to send to computing device 100C. The reply message indicates the outcome and the status of the automatic network debug message that was received (e.g., whether a debug session was started, etc.). According to one embodiment of the invention, the response is within a replying protocol NIE and may take the following form:

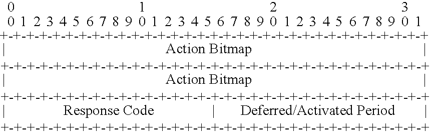

The action bitmap field is relayed back to computing device 100A to convey which actions encoded in the corresponding requesting protocol NIE were successfully enabled (i.e., whether a debug session was started for that action) or scheduled to start. The response code field encodes the outcome and status in response to each requesting protocol NIE. The response code field may take the following form:

| Description | Value |
|---|---|
| Success | 0x0001 |
| Action Deferred | 0x0002 |
| Temporarily Unavailable | 0x0003 |
| Unexplained Failure | 0x0004 |
| Action Unsupported | 0x0005 |
| Administratively Prohibited | 0x0006 |
| Insufficient Resources | 0x0007 |
| Relay Unsupported | 0x0008 |
| Relay Address Error | 0x0009 |
| Relay Destination Unreachable | 0x0010 |
| Stateful Session Unsupported | 0x001A |
| Non-existent Action | 0x001B |
| Reserved | 0x001C-0xFFFF |

The deferred/activated period field is a period of time that an automatic network debug session is enabled or deferred for by the receiving computing device. The deferred/activated period field allows the triggering computing device to determine if additional debugging sessions are required according to one embodiment of the invention.

Once the debug session has started, it is important to be able to control and appropriately stop the debug session. The debug message generation code block(s) with optional automatic stop 109 generates debug messages during the debug session. Check Flag(s) check flags in the debug library 145B at a time 9 according to the reformed actions received. Debug message generation code block(s) with optional automatic stop 109 are interspersed in the code for code module B. Thus, upon encountering these points in the code the debug library 145B is checked to determine whether the code associated with the debug flag should be executed (and thus generate a debug message).

Also within debug message generation code block(s) with optional automatic stop 109 is check logging 170. Check logging 170 is performed to determine whether each debug message should be logged. According to one embodiment of the invention each reformed action received by the code module includes a log attribute that indicates whether logging of the debug messages is enabled. Check logging 170 uses the reformed action attributes storage 190B to determine whether to log the debug message. If logging is enabled for the reformed action received at code module B, at a time 10 check logging 170 sends the debug message to logging module 155. According to one embodiment of the invention logging module 155 further sends the debug messages to an external computing device by using any known means of propagating messages to an external computing device (e.g., syslog). According to another embodiment of the invention, logging module 155 sends the debug messages to an internal memory for local storage.

Also within debug message generation code block(s) with optional automatic stop 109 is check for automatic stop criterion 180. According to one embodiment of the invention, one or more stop criterions are included as attributes in the reformed actions received. For example, the duration attribute indicates the time in which to automatically stop the debug session. As another example, an interrupt attribute may be included in the reformed action to indicate whether the debug session can be interrupted by a user, and a counter attribute may be included in the reformed action to indicate how many debug messages are generated before the debug session is automatically stopped. According to another embodiment of the invention, a code module may transmit an explicit stop criterion to another code module that currently is operating a debug session. For example, referring to FIG. 1, code module A has triggered a debug session to be started on code module B. Code module A may send code module B an explicit stop criterion upon determining that the debug session is no longer needed. According to one embodiment of the invention, code module A requests automatic network debug message process 114A to form an automatic network debug message that includes a requesting protocol NIE session state indicating that the debug session(s) on code module B should be stopped (e.g., session stop), suspended (e.g., session suspend), etc. Additionally, code module A may request automatic network debug message process 114A to form an automatic network debug message that includes a requesting protocol NIE session state indicating that a debug session be updated with a new action (e.g., session update), that a suspended debug session should be resumed (e.g., session resume), etc.

In another embodiment of the invention, one or more stop criterions are included within a local profile of each code module. The one or more stop criterions included within the local code module profile may override or modify the one or more stop criterions included in the reformed actions received. That is, the local code module profile may be configured to accept the one or more stop criterions included with the reformed action, partially accept the one or more stop criterions included with the reformed action, or reject the one or more stop criterions included with the reformed action. For example, the duration attribute in the reformed actions received may be greater than or less than the duration as defined in the local code module profile. The local profile may be configured to accept the duration attribute defined in the reformed action or it may reject the duration attribute.

Regardless of which stop criterion is detected, once the stop criterion is received and accepted by a code module, the flags in the library are reset and the debug messages cease to be generated. Thus, if a stop criterion is received and accepted by the code module, the debug flag(s) are reset and the debug session is automatically stopped.

Thus, in one embodiment of the invention, in addition to automatically triggering the start of one or more debug sessions (i.e., without user action), the debug session is also automatically triggered to stop based on one or more stop criterions. As debug sessions are overhead both in the computing device and the particular code module in which the debug session is running, automatically stopping the debug session conserves resources (e.g., processing load, memory load, disk load, etc.). Furthermore, in addition to automatically starting one or more debug sessions based on a certain automatic start network debug session condition, the number of debug messages generated is limited which provides a user (e.g., a network administrator) the ability to manage the debug messages and use the knowledge obtained from the debug messages efficiently.

In addition to directly triggering debug sessions to automatically start on a computing device that is directly connected (as was the case in FIG. 1), debug sessions may be automatically triggered on computing devices that are not directly connected to the computing device. For example, in certain circumstances a triggering computing device is unable to reach certain of the destination computing devices. For example, referring to FIG. 6A, computing device 100A is not directly connected with computing device 100C. For example, if computing device 100A is a border gateway protocol (BGP) router, computing device 100A may want to send actions to all source autonomous systems (AS) routers and all destination AS routers. In order to send actions to destinations that are not directly connected, computing device 100A includes a structure of indirect computing devices and their possible reachability information through a reachable computing device (e.g., a directly connected computing device). While in one embodiment the structure of indirect computing devices and their possible reachability information is a table, in alternative embodiments the structure of indirect computing devices and their possible reachability information is a different data structure (e.g., a linked list, tree, etc.).

According to one embodiment of the invention, an address list NIE is used by a triggering computing device to encode the destinations that a receiving computing device should be relaying the automatic network debug message to. For example, the address list NIE format may be defined as the following:

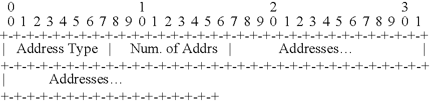

The address type of the address list NIE describes the type of addresses that are used for relaying the automatic network debug messages (e.g., MAC address, IPv4, IPv6, etcl). The number of address in the address list NIE describes the number of distinct addresses present in the address list NIE. The addresses field of the address list NIE describes the actual addresses that will be relayed. As previously described, if the flag field ‘R’ in the automatic network debug message header is set, then a relay is requested and the address list NIE should be processed.

Referring to FIG. 6A, according to one embodiment of the invention, if the triggering computing device (e.g., computing device 100A) determines that numerous receiving computing devices (e.g., computing devices 100B and 100C) should start a debug session, and computing device 100C is not directly reachable from computing device 100A, computing device 100A specifies that a relay is requested and specifies the relay destination. For example, computing device 100A sets the flag ‘R’ in the automatic network debug message header to indicate that a relay is required, and also includes the destination address of computing device 100C in an address list NIE. Thus, computing device 100A has both requested a relay and furnished which computing devices should receive the relayed automatic network debug message.

At a time 1, computing device 100A sends computing device 100B an automatic network debug message that includes a relay request and destination addresses for the relay. The source of the automatic network debug message is computing device 100A, and the origin of the automatic network debug message is also computing device 100A. According to one embodiment of the invention, computing device 100B may refrain from relaying or processing the automatic network debug message based on the source or the origin of the automatic network debug message. For example, computing device 100B may be configured such that it will not accept relay requests from computing device 100A. For example, in one embodiment of the invention the computing devices that participate in this scheme register with one another. If computing device 100A is not registered to participate in the debugging process, then computing device 100B may reject the automatic network debug message. By rejecting automatic network debug messages from computing devices that are not registered to or known to the receiving computing device, the receiving computing device may guard against malicious activities (e.g., denial of service attacks, multiple false triggering of debug sessions, etc.).

Note that the destination of this first automatic network debug message is computing device 100B. While in one embodiment of the invention if a relay is requested the relaying computing device does not start a debug session according to the automatic network debug message, in an alternative embodiment of the invention the relaying computing device automatically starts a debug session according to the automatic network debug message and further relays the automatic network debug message to the destinations indicted in the address list NIE.

Assuming that computing device 100B is willing to forward the automatic network debug message, at a time 2 computing device 100B forwards the automatic network debug message to computing device 100C. Note that the source of this automatic network debug message has changed to computing device 100B, but the origin of the automatic network debug message remains 100A. Similarly as discussed above, computing device 100C may be configured to ignore the automatic network debug message based on the source of the message or the origin of the message.

Thus, computing device 100A has indirectly sent an automatic network debug message to computing device 100B and computing device 100C. Thus, computing device 100A is attempting to trigger the start of automatic network debug sessions on computing device 100B and computing device 100C. Computing device 100B and computing device 100C process the automatic network debug message in a similar fashion as was described with reference to FIG. 1 (e.g., the automatic network debug manager of each computing device decodes the automatic network debug message and forwards reformed action to the appropriate code modules, and the code modules set one or more flags in the debug library of that computing device).

In addition to relaying the automatic network debug message according to the address list NIE, according to one embodiment of the invention a relaying computing device may also relay the automatic network debug message to computing devices not are not represented in the address list NIE. FIG. 6B illustrates a first device (computing device 100A) indirectly triggering a debug session on a second device (computing device 100D) through an intermediary device (computing device 100B) according to another embodiment of the invention. At a time 1, computing device 100A has sent to computing device 100B an automatic network debug message with a relay request and zero or more target destinations (e.g., the automatic network debug message did not include an address NIE or includes an address NIE). At a time 2, computing device 100B has forwarded the automatic network debug message to a computing device that was not listed in the address list NIE (computing device 100D). It should be understood that computing device 100B may also forward the automatic network debug messages to the destination addresses included in the address list NIE. Thus, at a time 3, computing device 100B forwards the automatic network debug message to computing device 100C which was included in the address list NIE. Note that in this case, although computing device 100A did not request that the automatic network debug message be forwarded to computing device 100D, the origin of the automatic network debug message remains computing device 100A. Computing device 100B, computing device 100C, and computing device 100D process the automatic network debug message in a similar fashion as was described with reference to FIG. 1.

Thus, computing device 100B has extended the relay request received from computing device 100A by making an independent determination of which computing devices should receive the automatic network debug message. According to one embodiment of the invention, upon computing device 100B receiving the automatic network debug message with a relay requested, the automatic network debug process interface 114B determines an automatic start network debug session condition based on the action bitmap of the requesting protocol NIE. The automatic network debug process also determines the requesting protocol ID of the requesting protocol NIE and determines if it has any directly connected computing devices that have similar automatic start network debug session conditions for modules corresponding to the requesting protocol ID. Referring to FIG. 5, in one embodiment of the invention a directly connected computing devices with similar automatic start network debug session conditions structure 514B is used in this determination. This structure may be populated by a per automatic start network debug session condition or by a per code module of a computing device. As one example, this structure may be populated from information gathered from previous automatic network debug messages.

According to another embodiment of the invention, computing device 100B determines to forward the automatic network debug message to one or more computing devices not included in the address list NIE in a different fashion. For example, computing device 100B determines an automatic start network debug session condition based on the received automatic network debug message and treats this automatic start network debug session condition as if originally detected on computing device 100B. Thus, according to this embodiment of the invention, one or more actions are determined for this condition and destinations of the actions are determined in a similar fashion as was described with reference to code module A of computing device 100A in FIG. 1.

According to another embodiment of the invention, computing device 100B determines to forward the automatic network debug message to one or more computing devices where the automatic network debug message does not include a relay request in order to facilitate a greater amount of debug sessions. For example, FIG. 6C illustrates a first computing device (computing device 100A) automatically triggering a debug session on a second computing device (computing device 100B) and the second device automatically triggering a debug session on a third computing device (computing device 100D) according to one embodiment of the invention. Referring to FIG. 6C, at a time 1 an automatic network debug message with no relay request (and thus no addresses for destination computing devices) is sent from computing device 100A to computing device 100B. The computing device 100B, in addition to processing the automatic network debug message locally on computing device 100B (e.g., determining whether to start a debug session on computing device 100B according to the automatic network debug message), determines to send a different automatic network debug message to one or more computing devices.

According to one embodiment of the invention, computing device 100B maintains an affinity computing devices structure. For example, referring to FIG. 5, automatic network debug message process 114B includes affinity computing devices structure 506B. The affinity computing devices structure 506B may be statically configured by a network administrator or dynamically learned from various code modules that participate in automated network debugging. For example, code modules that participate in automated network debugging register with the automatic network debug manager module of a computing device, and the computing device advises other computing devices in the network of these registrations. With this information, a computing device may create an affinity computing devices structure by including those computing devices which are configured in a state closest to that computing device. For example, if computing device 100B is a switch, affinity computing devices of computing device 100B may be other switches or gateway routers. Referring back to FIG. 6C, computing device 100D is an affinity computing device of computing device 100B.

According to another embodiment of the invention, computing device 100B may maintain an action to automatically start debug session condition reverse mapping structure. Referring to FIG. 5, automatic network debug process interface 114B includes an action to automatically start debug session condition reverse mapping structure 508B. In one embodiment of the invention this structure may be derived from the automatic start network debug session condition structure by searching for actions that are mapped from these automatic start network debug session conditions. As a single automatic start network debug session condition may be associated with one or more actions, a single action may be reverse mapped to one or more automatic start network debug conditions. In an alternative embodiment of the invention, the action to automatically start debug session condition reverse mapping structure 508B is defined by a network administrator.

Regardless of how computing device 100B decides that computing device 100D should get an automatic network debug message, at a time 2, computing device 100B sends an automatic network debug message to computing device 100B. Note that, unlike the previous situations where computing device 100A has requested a relay, the origin of this automatic network debug message is computing device 100B.

According to another embodiment of the invention, computing device 100B, acting purely as an intermediary computing device (i.e., the automatic network debug message is not destined to computing device 100B, may decide to send a reformed automatic network debug message to a different computing device than what is indicated in the original automatic network debug message. For example referring to FIG. 6D, at a time 1 computing device 100A sends an automatic network debug message to computing device 100C. However, computing device 100C is not directly connected with computing device 100A, thus the automatic network debug message is sent through computing device 100B. For example, computing device 100B may be at an intermediate point in the network (that is, in order to reach computing device 100C from computing device 100A, the automatic network debug message must pass through computing device 100B). Note that computing device 100A has not indicated that computing device 100B is to receive the automatic network debug message nor indicated that computing device 100B should perform any action on the automatic network debug message. Rather, computing device 100A only expects that computing device 100B will forward the automatic network debug message in an unchanged state to computing device 100C. However, according to one embodiment of the invention, computing device 100B listens for automatic network debug messages (e.g., snoops for automatic network debug messages) and acts on those automatic network debug messages when they are pertinent to computing device 100B.

A computing device with the capability of independently deciding to forward automatic network debug messages to different computing devices increases the robustness of the cumulative debug session based on an automatic start network debug session condition. For example, in the case of a rare problem in a network (e.g., a problem encountered infrequently that affects many computing devices in the network) that originates from one computing device, debug sessions may be automatically started on numerous computing devices which may provide insight into the cause of the rare problem and a resolution of that problem.

According to one embodiment of the invention, computing device 100B uses a combination of the properties of the listened (i.e., snooped) automatic network debug message (e.g., the properties associated with an action) and the destination address of the snooped automatic network debug message to determine whether to act on the message. For example, computing device 100B determines if an action contained in the automatic network debug message is supported on the computing device 100B (e.g., whether the automatic network debug message NIE protocol ID associated with the action is supported by computing device 100B). If the action is supported, the destination address of the automatic network debug message is checked to determine whether that destination address is in computing device 100B's affinity computing devices structure. If the destination address is in the affinity computing devices structure, then the destination computing device is related to computing device 100B and computing device 100A was not able to determine, or deliberately decided not to trigger a debug session on computing device 100B. For example, computing device 100A could not identify computing device 100B as a potential source of a problem causing the automatic start network debug session condition or as a computing device where generation of debug messages would be helpful for debugging the problem associated with the automatic start network debug session condition. After computing device 100B determines it is related to computing device 100A, computing device 100B may choose to process the snooped automatic network debug message and automatically start one or more debug sessions on computing device 100B according to the snooped automatic network debug message.

Thus, referring to FIG. 6D, at a time 1 computing device 100A sends an automatic network debug message destined for computing device 100C. At a time 2, computing device 100B snoops the automatic network debug message and determines to process the automatic network debug message (e.g., start one or more debug sessions corresponding with one or more actions included in the automatic network debug message). At a time 3, computing device 100B forwards the automatic network debug message to computing device 100C. It should be understood that if the automatic network debug message was encrypted by computing device 100A, then it is unlikely that computing device 100B is able to snoop the actions contained within the automatic network debug message.

Similarly to a computing device relaying automatic network debug messages, a computing device with the capability of snooping automatic network debug messages and processing that automatic network debug message increases the robustness of the cumulative debug session (i.e., increases the number of debug messages generated) based on an automatic start network debug session condition. In the case of a rare problem in the network (e.g., a problem encountered infrequently that affects many computing devices in the network) that originates from one computing device, it may be helpful to obtain debug messages from many devices that may be affected by the problem, or part of the problem, and a computing device that snoops an automatic network debug message to determine if it should generate debug messages relative to that automatic network debug message increases the cumulative amount of knowledge gained from that single automatic network debug message. In addition, without snooping, it may be possible that the computing device will not automatically start a debug session even though it may be helpful.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.)

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computer implemented method for a first computing device automatically triggering across a network one or more debug sessions to start on a second computing device, comprising:
determining, at a first code module in the first computing device, a detected event constitutes an automatic start network debug session condition, wherein the detected event is an occurrence of significance to the first code module, and wherein the automatic start network debug session condition is a set of one or more start criterions of which the detected event is a part;
determining one or more actions for that automatic start network debug session condition, wherein each action includes properties of a different one of the one or more debug sessions;
determining that a destination of at least one of the actions is the second computing device;
forming an automatic network debug message for each action destined for the second computing device, wherein the automatic network debug message is based on that action and wherein the automatic network debug message indicates the properties of the debug session;
transmitting each automatic network debug message destined for the second computing device to the second computing device;
upon receipt of the automatic network debug messages, the second computing device processing each received automatic network debug message, wherein processing includes,
reforming the action from the received automatic network debug message, and
sending the reformed action to a local code module upon determining that the local code module should automatically start a debug session;
setting one or more flags according to each reformed action to start the debug session corresponding to each reformed action; and
generating a set of one or more debug messages corresponding to the flags that are set.

2. The computer implemented method of claim 1, wherein at least one of the one or more actions includes at least one stop criterion to automatically stop that corresponding debug session, and further comprising,
for each reformed action including the at least one stop criterion,
determining to automatically stop the debug session that corresponds to that reformed action according to the stop criterion, and
resetting the flags that correspond to that action.

3. The computer implemented method of claim 1 further comprising logging the one or more debug messages upon determining that the reformed action indicates that logging is enabled.

4. The computer implemented method of claim 1 further comprising the second computing device performing a system check that results in determining that the second computing device allows each of the one or more debug sessions to be started.

5. The computer implemented method of claim 1 further comprising the second computing device performing a code module check that results in determining the code modules on the second computing device allow the one or more debug sessions to be started, wherein the code module check is based on a configured profile of the code modules.

6. The computer implemented method of claim 1 further comprising the first computing device triggering an automatic stop of at least one debug session that has started on the second computing device.

7. The computer implemented method of claim 1, further comprising the second computing device,
determining that a third computing device should start at least one debug session, and
transmitting the automatic network debug message to the third computing device to trigger at least one debug session on that third computing device to automatically start.

8. The computer implemented method of claim 1, further comprising the first code module at the first computing device requesting that the second computing device should forward the automatic network debug message to a third computing device to automatically trigger one or more debug sessions on the third computing device.

9. A network configured for automatic debugging, comprising:
a first computing device, the first computing device including,
a first set of one or more code modules, each code module to
determine that one or more debug sessions should be started on a second computing device, and
determine properties of each of the one or more debug sessions,
a first automatic network debug manager module to form an automatic network debug message based on the properties of each of the one or more debug sessions, and to send the automatic network debug message to the second computing device to trigger the one or more debug sessions corresponding to the properties; and
the second computing device including,
a second automatic network debug manager module to,
receive the automatic network debug message,
reform the properties of each of the one or more debug sessions from the received automatic network debug message, and
send the reformed properties to a second set of one or more code modules in the second computing device,
the second set of code modules to set one or more flags according to the reformed properties to start the one or more debug sessions corresponding to the reformed properties, wherein one or more debug messages are generated corresponding to the flags that are set.

10. The network of claim 9, further comprising at least one of the properties including one or more stop criterions which when met automatically stop the debug session corresponding to those properties.

11. The network of claim 9 further comprising the second set of code modules to determine that the one or more generated debug messages are to be logged, and to cause those one or more debug messages to be transmitted to a logging module.

12. The network of claim 9 wherein the second automatic network debug manager module further to perform a system check to determine whether the second computing device allows the one or more debug sessions to start.

13. The network of claim 9 wherein each of the second set of code modules further to perform a code module check to determine whether each of the second set of code modules allows the one or more debug sessions to start, wherein each code module check is based on a configured profile of each of the second set of code modules.

14. The network of claim 9 further comprising the first computing device to trigger the second computing device to automatically stop at least one debug session.

15. The network of claim 9 further comprising the second automatic network debug manager module further to,
determine that a third computing device should start at least one debug session, and
transmit the automatic network debug message to the third computing device to trigger at least one debug session on that third computing device to automatically start.

16. The network of claim 9 further comprising the first automatic network debug manager module to include in the automatic network debug message a request to the second computing device to forward the automatic network debug message to a third computing device to automatically trigger one or more debug sessions on the third computing device.

17. A machine-readable medium that provides instructions that, if executed by a processor, will cause said processor to perform operations for a first computing device automatically triggering across a network one or more debug sessions to start on a second computing device, comprising:
determining, at a first code module in the first computing device, a detected event constitutes an automatic start network debug session condition, wherein the detected event is an occurrence of significance to the first code module, and wherein the automatic start network debug session condition is a set of one or more start criterions of which the detected event is a part;
determining one or more actions for that automatic start network debug session condition, wherein each action includes properties of a different one of the one or more debug sessions;
determining that a destination of at least one of the actions is the second computing device;
forming an automatic network debug message for each action destined for the second computing device, wherein the automatic network debug message is based on that action and wherein the automatic network debug message indicates the properties of the debug session;
transmitting each automatic network debug message destined for the second computing device to the second computing device;
upon receipt of the automatic network debug messages, the second computing device processing each received automatic network debug message, wherein processing includes,
reforming the action from the received automatic network debug message, and
sending the reformed action to a local code module upon determining that the local code module should automatically start a debug session;
setting one or more flags according to each reformed action to start the debug session corresponding to each reformed action; and
generating a set of one or more debug messages corresponding to the flags that are set.

18. The machine-readable medium of claim 17, wherein at least one of the one or more actions includes at least one stop criterion to automatically stop that corresponding debug session, and further comprising,
for each reformed action including the at least one stop criterion,
determining to automatically stop the debug session that corresponds to that reformed action according to the stop criterion, and
resetting the flags that correspond to that action.

19. The machine-readable medium of claim 17 further comprising logging the one or more debug messages upon determining that the reformed action indicates that logging is enabled.

20. The machine-readable medium of claim 17 further comprising the second computing device performing a system check that results in determining that the second computing device allows each of the one or more debug sessions to be started.

21. The machine-readable medium of claim 17 further comprising the second computing device performing a code module check that results in determining the code modules on the second computing device allow the one or more debug sessions to be started, wherein the code module check is based on a configured profile of the code modules.

22. The machine-readable medium of claim 17 further comprising the first computing device triggering an automatic stop of at least one debug session that has started on the second computing device.

23. The machine-readable medium of claim 17, further comprising the second computing device,
determining that a third computing device should start at least one debug session, and
transmitting the automatic network debug message to the third computing device to trigger at least one debug session on that third computing device to automatically start.

24. The machine-readable medium of claim 17, further comprising the first code module at the first computing device requesting that the second computing device should forward the automatic network debug message to a third computing device to automatically trigger one or more debug sessions on the third computing device.
